(19) United States
(12) Patent Application Publication
(10) Pub. No.: US 2023/0411617 A1
(43) Pub. Date: Dec. 21, 2023

(54) Lithium Halide-based Nanocomposite, Preparing Method Thereof, and Positive Electrode Active Material, Solid Electrolyte, and All-solid-state Battery Comprising the Same

(71) Applicants: UIF (University Industry Foundation), Yonsei University, Seoul (KR); UNIST(ULSAN NATIONAL INSTITUTE OF SCIENCE AND TECHNOLOGY), Ulsan (KR)

(72) Inventors: Yoon Seok JUNG, Seoul (KR); Hiram KWAK, Seoul (KR); Dong-Hwa SEO, Ulsan (KR); JAESEUNG KIM, Ulsan (KR)

(21) Appl. No.: 18/337,629

(22) Filed: Jun. 20, 2023

(30) Foreign Application Priority Data
Jun. 20, 2022 (KR) 10-2022-0074829

(51) Int. Cl. H01M 4/58; H01M 4/36; H01M 10/0562; H01M 4/485

(52) U.S. Cl. CPC H01M 4/582; H01M 4/366; H01M 10/0562; H01M 4/485; H01M 2004/028

(57) ABSTRACT

Disclosed are a lithium halide-based nanocomposite, a method of preparing the same, a solid electrolyte including the lithium halide-based nanocomposite, and an all-solid-state battery including the solid electrolyte, the lithium halide-based nanocomposite including a nanosized compound selected from M¹O_{c}, LiX, and a combination thereof dispersed in a halide compound.

### CROSS-REFERENCE TO RELATED APPLICATION

This application claims priority to and the benefit of Korean Patent Application No. 10-2022-0074829 filed in the Korean Intellectual Property Office on Jun. 20, 2022, the entire contents of which are incorporated herein by reference.

### BACKGROUND OF THE INVENTION

### (a) Field of the Invention

This disclosure relates to a lithium halide-based nanocomposite, a preparing method thereof, and a positive electrode active material, a solid electrolyte, and an all-solid-state battery.

### (b) Description of the Related Art

Recently, lithium ion batteries are expanding from power sources for small mobile devices to power sources for electric vehicles and energy storage devices (ESS) such as medium and large-sized pure electric vehicles (EVs) and hybrid electric vehicles (HEVs). In particular, interest in electric vehicles, which are eco-friendly vehicles, is very high, and major automakers around the world are accelerating technology development by recognizing electric vehicles as a next-generation growth technology under the motto of eco-friendliness. In the case of medium-sized and large-sized lithium-ion batteries, unlike small-sized lithium-ion batteries, it is essential to secure safety because they include many batteries as well as harsh operating environments such as temperature or shock. Accordingly, as industrial fields requiring lithium ion batteries expand their application range to large batteries, interest in safety issues of lithium ion batteries is also greatly increasing.

Existing lithium-ion batteries have problems such as low thermal stability, ignitability, and leakage because organic liquid electrolytes are used. In fact, as explosion accidents of products applied with this technology are continuously reported, it is urgently required to solve these problems. Accordingly, an all-solid-state battery using a solid electrolyte is emerging as an alternative.

In order to exhibit the performance of such an all-solid-state battery, it is necessary to have excellent contact characteristics between particles of a solid electrolyte and an active material. Accordingly, sulfide-based solid electrolytes are electrochemically excellent and have better ductile properties than oxide-based solid electrolytes with hard mechanical properties, so that close contact between solid electrolyte and active material particles may be achieved only by cold pressing due to particle characteristics. This has the advantage of obtaining an all-solid-state battery with improved lithium ionic conductivity.

The sulfide-based solid electrolytes may be prepared only by simple cold pressing due to their high ionic conductivity and brittle mechanical properties, but have low electrochemical stability and inferior atmospheric stability compared to oxide-based solid electrolytes, which may cause difficulties in the manufacturing process of all-solid-state batteries. In addition, there are inherent risk factors due to the generation of H₂S gas in the manufacturing process. In order to solve the above problems, various studies have been conducted on halide-based solid electrolytes.

For example, studies using Li₃YCl₆ and Li₃YBr₆ have been conducted to improve atmospheric stability, which is a problem of sulfide-based solid electrolytes. As a central element material is a rare earth material, there is still a problem in the manufacturing process of the all-solid-state battery in terms of toxicity or price. In addition, there is also a problem that side reactions between sulfide and halide-based solid electrolytes occur at high voltage when applied to an all-solid-state battery at the same time as a sulfide solid electrolyte.

In addition, for the competitiveness of halide-based solid electrolytes, methods such as central metal or anion substitution are being studied to improve ionic conductivity to the level of sulfide-based materials, but there is still a limit to improving ionic conductivity.

### SUMMARY OF THE INVENTION

An embodiment provides a lithium halide-based nanocomposite that can provide a solid electrolyte for a rechargeable lithium battery with improved ionic conductivity and electrochemical oxidation stability.

Another embodiment provides a method of preparing the lithium halide-based nanocomposite.

Another embodiment provides a positive electrode active material for a rechargeable lithium battery including the lithium halide-based nanocomposite.

Another embodiment provides a solid electrolyte for a rechargeable lithium battery including the lithium halide-based nanocomposite and a sulfide based solid electrolyte.

Another embodiment provides a double-layer solid electrolyte for a rechargeable lithium battery including the lithium halide-based nanocomposite.

Another embodiment provides an all-solid-state battery including the solid electrolyte.

Another embodiment provides an all-solid-state battery including the double-layer solid electrolyte.

An embodiment provides a lithium halide-based nanocomposite represented by any one of Chemical Formulas 1A to 1C, in which a nanosized compound selected from M¹O_{c}, LiX, and a combination thereof is dispersed in a halide compound of LiₐM²X_{b}.

M¹O_{c}—LiₐM²X_{b} [Chemical Formula 1A]

In Chemical Formula 1A, M¹ and M² are different from each other and are each independently one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X is Cl, Br, F, or I, and a, b, and c are each independently in the range of 0.01 to 10.

LiX—LiₐM²X_{b} [Chemical Formula 1B]

In Chemical Formula 1B, M² is one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X is Cl, Br, F, or I, and a and b are each independently in the range of 0.01 to 10.

M¹O_{c}—LiX—LiₐM²X_{b} [Chemical Formula 1C]

In Chemical Formula 1C, M¹ and M² are different from each other and are each independently one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X is Cl, Br, F, or I, and a, b, and c are each independently in the range of 0.01 to 10.

In LiₐM²X_{b} of Chemical Formulas 1A to 1C, X_{b} may be X¹_{b-d}X²_{d} wherein X¹ and X² may be different from each other and may each independently be Cl, Br, F, or I, b may be in the range of 0.01 to 10, and d may be in the range of 0.01 to 4.

In LiₐM²X_{b} of Chemical Formulas 1A to 1C, X_{b} may be Cl_{b-d}F_{d} or Cl_{b-d}I_{d}, b may be in the range of 0.01 to 10, and d may be the range of 0.01 to 4.

The lithium halide-based nanocomposite represented by Chemical Formula 1A may include about 1 to about 20 vol % of M¹O_{c} and about 80 to about 99 vol % of LiₐM²X_{b}; the lithium halide-based nanocomposite represented by Chemical Formula 1B may include about 6 to about 34 vol % of LiX and about 66 to about 94 vol % of LiₐM²X_{b}; and the lithium halide-based nanocomposite represented by Chemical Formula 1C may include about 1 to about 13 vol % of M¹O_{c}, about 1 to about 29 vol % of LiX, and about to about 94 vol % of LiₐM²X_{b}.

The nanosized compound selected from M¹O_{c}, LiX, and the combination thereof may be an in-situ grown compound and may have a crystal size of less than or equal to about 100 nm.

The nanosized compound selected from M¹O_{c}, LiX, and the combination thereof may be formed in a network shape inside a halide compound (LiₐM²X_{b}).

The lithium halide-based nanocomposite may have an ionic conductivity of about to about 5 mS/cm at 30° C.

The lithium halide-based nanocomposite may have a glass-ceramic crystal structure.

The lithium halide-based nanocomposite may exhibit a first effective peak and a second effective peak in the ranges of about 0.4 to about 0.6 ppm and about −0.2 to about ppm, respectively, in a ⁶Li MAS NMR analysis result, and an intensity ratio of the first effective peak to the second effective peak may be about 0.7 to about 0.8. Another embodiment provides a lithium halide-based nanocomposite represented by any one of Chemical Formulas 2A to 2C, in which a nanosized compound selected from M¹O_{c}, LiX, and a combination thereof is dispersed in a halide compound of LiₐM²X¹_{b-d}X²_{d}.

M¹O_{c}—LiₐM²X¹_{b-d}X²_{d} [Chemical Formula 2A]

In Chemical Formula 2A, M¹ and M² are the same or different, and are each independently one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X¹ and X² are different from each other and are each independently Cl, Br, F, or I, a, b, and c are each independently in the range of 0.01 to 10, and d is in the range of 0.01 to 4.

LiX—LiₐM²X¹_{b-d}X²_{d} [Chemical Formula 2B]

In Chemical Formula 2B, M² is one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X is Cl, Br, F, or I, X l and X² are different from each other and are each independently Cl, Br, F, or I, a and b are each independently in the range of 0.01 to 10, and d is in the range of 0.01 to 4.

M¹O_{c}—LiX—LiₐM²X¹_{b-d}X²_{d} [Chemical Formula 2C]

In Chemical Formula 2C, M¹ and M² are each independently one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X is Cl, Br, F, or I, X¹ and X² are different from each other and are each independently Cl, Br, F, or I, a, b, and c are each independently in the range of 0.01 to 10, and d is in the range of 0.01 to 4.

LiₐM²X¹_{b-d}X²_{d} in Chemical Formulas 2A to 2C may be LiₐM²Cl_{b-d}F_{d} or LiₐM²Cl_{b-d}I_{d}, wherein a and b may be in the range of 0.01 to 10, and d may be in the range of 0.01 to 4.

In LiₐM²X¹_{b-d}X²_{d} of Chemical Formulas 2A to 2C, a portion of M² may be substituted with M³ to be a compound represented by LiₐM²₁₋ₑM³ₑX¹_{b-d}X²_{d}, wherein M², X¹, X², a, b, and d are the same as in Chemical Formulas 2A to 2C, and M 3 may be the same as or different from M l, and may be one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, and e may be in the range of 0.01 to 0.9.

The lithium halide-based nanocomposite represented by Chemical Formula 2A may include about 1 to about 20 vol % of M¹O_{c} and about 80 to about 99 vol % of LiₐM²X¹_{b-d}X²_{d}; the lithium halide-based nanocomposite represented by Chemical Formula 2B may include about 6 to about 34 vol % of LiX and about 66 to about 94 vol % of LiₐM²X¹_{b-d}X²_{d}; and the lithium halide-based nanocomposite represented by Chemical Formula 2C may include about 1 to about 13 vol % of M¹O_{c}, about 1 to about 29 vol % of LiX, and about 65 to about 94 vol % of LiₐM²X¹_{b-d}X²_{d}.

The nanosized compound selected from M¹O_{c}, LiX, and the combination thereof may be an in-situ grown compound and may have a crystal size of less than or equal to about 100 nm.

The nanosized compound selected from M¹O_{c}, LiX, and the combination thereof may be formed in a network shape inside a halide compound (LiₐM²X¹_{b-d}X²_{d}).

The lithium halide-based nanocomposite may have an ionic conductivity of about to about 5 mS/cm at 30° C.

The lithium halide-based nanocomposite may have a glass-ceramic crystal structure.

The lithium halide-based nanocomposite may exhibit a first effective peak and a second effective peak in the ranges of about 0.4 to about 0.6 ppm and about −0.2 to about ppm, respectively, in a ⁶Li MAS NMR analysis result, and an intensity ratio of the first effective peak to the second effective peak may be about 0.7 to about 0.8.

Another embodiment provides a lithium halide-based nanocomposite represented by any one of Chemical Formulas 3A to 3C, in which a nanosized compound selected from M¹O_{c}, LiX, and a combination thereof is dispersed in a halide compound of LiₐM²₁₋ₑM³ₑX_{b}.

M¹O_{c}—LiₐM²₁₋ₑM³ₑX_{b} [Chemical Formula 3A]

In Chemical Formula 3A, M¹, M², and M³ are each independently one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X is Cl, Br, F, or I, M² and M³ are different from each other, a, b, and c are each independently in the range of 0.01 to 10, and e is in the range of 0.01 to 0.9.

LiX—LiₐM²₁₋ₑM³ₑX_{b} [Chemical Formula 3B]

In Chemical Formula 3B, M² and M³ are different from each other and are each independently one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X is Cl, Br, F, or I, a and b are each independently in the range of 0.01 to 10, and e is in the range of 0.01 to 0.9.

M¹O_{c}—LiX—LiₐM²₁₋ₑM³ₑX_{b} [Chemical Formula 3C]

In Chemical Formula 3C, M¹, M², and M³ are each independently one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X is Cl, Br, F, or I, a, b, and c are each independently in the range of 0.01 to 10, and e is in the range of 0.01 to 0.9.

In LiₐM²₁₋ₑM³ₑX_{b} of Chemical Formula 3A to 3C, X_{b} may be X¹_{b-d}X²_{d} wherein X¹ and X² may be different from each other and may each independently be Cl, Br, F, or I, b may be in the range of 0.01 to 10, and d may be in the range of 0.01 to 4.

In LiₐM²₁₋ₑM³ₑX_{b} of Chemical Formulas 3A to 3C, X_{b} may be Cl_{b-d}F_{d} or Cl_{b-d}I_{d}, b may be in the range of 0.01 to 10, and d may be in the range of 0.01 to 4.

The lithium halide-based nanocomposite represented by Chemical Formula 3A may include about 1 to about 20 vol % of M¹O_{c} and about 80 to about 99 vol % of LiₐM²₁₋ₑM³ₑX_{b}; the lithium halide-based nanocomposite represented by Chemical Formula 3B may include about 6 to about 34 vol % of LiX, and about 66 to about 94 vol % of LiₐM²₁₋ₑM³ₑX_{b}; and the lithium halide-based nanocomposite represented by Chemical Formula 3C may include about 1 to about 13 vol % of M¹O_{c}, about 1 to about 29 vol % of LiX, and about 65 to about 94 vol % of LiₐM²₁₋ₑM³ₑX_{b}.

The nanosized compound selected from M¹O_{c}, LiX, and the combination thereof may be an in-situ grown compound and may have a crystal size of less than or equal to about 100 nm.

The nanosized compound selected from M¹O_{c}, LiX, and the combination thereof may be formed in a network shape inside a halide compound (LiₐM²₁₋ₑM³ₑX_{b}).

The lithium halide-based nanocomposite may have an ionic conductivity of about 0.1 to about 5 mS/cm at 30° C.

The lithium halide-based nanocomposite may have a glass-ceramic crystal structure.

The lithium halide-based nanocomposite may exhibit a first effective peak and a second effective peak in the ranges of about 0.4 to about 0.6 ppm and about −0.2 to about 0.2 ppm, respectively, in a ⁶Li MAS NMR analysis result, and an intensity ratio of the first effective peak to the second effective peak may be about 0.7 to about 0.8.

Another embodiment provides a method of preparing the lithium halide-based nanocomposite represented by any one of Chemical Formulas 1A to 1C which includes performing a solid-phase reaction of a lithium-containing oxidizing agent and a first metal (M¹)-containing halide under an inert gas atmosphere to obtain first metal (M¹) oxide and a lithium halide, and performing a solid-phase reaction of the first metal (M¹) oxide, lithium halide, and second metal (M²)-containing halide.

Another embodiment provides a method for preparing a lithium halide-based nanocomposite represented by any one of Chemical Formulas 2A to 2C which includes
performing a solid-phase reaction of a lithium-containing oxidizing agent; a first halide of first metal (M¹) or a second metal (M²) and a second halide of first metal (M¹) or second metal (M²); and a lithium-containing first halide and a lithium-containing second halide under an inert gas atmosphere to prepare a lithium halide-based nanocomposite in which M¹ and M² are same in Chemical Formulas 2A to 2C; or
performing a solid-phase reaction of a lithium-containing oxidizing agent, a first metal (M¹)-containing first halide, and a first metal (M¹)-containing second halide under an inert gas atmosphere to obtain a first metal (M¹) oxide, a lithium-containing first halide, and a lithium-containing second halide, and performing a solid-phase reaction of the first metal (M¹) oxide, lithium-containing first halide, lithium-containing second halide, second metal (M²)-containing first halide, and second metal (M²)-containing second halide to prepare a lithium halide-based nanocomposite in which M¹ and M² are different from each other in Chemical Formulas 2A to 2C.

Another embodiment provides a method for preparing a lithium halide-based nanocomposite represented by any one of Chemical Formulas 3A to 3C which includes
performing a solid-phase reaction of a lithium-containing oxidizing agent, a first metal (M¹)-containing halide, and optionally a lithium halide under an inert gas atmosphere to prepare the lithium halide-based nanocomposite in which M¹ and M² are same in Chemical Formulas 1A to 1C; or
performing a solid-phase reaction of a lithium-containing oxidizing agent and a first metal (M¹)-containing halide under an inert gas atmosphere to obtain first metal (M¹) oxide and a lithium halide; and performing a solid-phase reaction of the first metal (M¹) oxide, lithium halide, and second metal (M²)-containing halide to prepare a lithium halide-based nanocomposite in which M¹ and M² are different from each other in Chemical Formulas 1A to 1C, and
performing a solid-phase reaction of the lithium halide-based nanocomposite, a third metal (M³)-containing halide and optionally lithium halide to prepare the lithium halide-based nanocomposite represented by any one of Chemical Formulas 3A to 3C.

The lithium-containing oxidizing agent is the same as described above.

Another embodiment includes a positive electrode active material for a rechargeable lithium battery including a core including a composite metal oxide capable of reversible intercalation/deintercalation of lithium; and a shell disposed on the core and including the lithium halide-based nanocomposite.

Another embodiment provides a solid electrolyte for a rechargeable lithium battery including the lithium halide-based nanocomposite and a sulfide-based solid electrolyte.

Another embodiment provides a double-layer solid electrolyte for a rechargeable lithium battery which includes a solid electrolyte for a positive electrode including the lithium halide-based nanocomposite; and a solid electrolyte for a negative electrode disposed on the solid electrolyte for the positive electrode and including a sulfide-based solid electrolyte.

Another embodiment provides an all-solid-state battery including a positive electrode; a negative electrode; and the solid electrolyte between the positive electrode and the negative electrode.

Another embodiment provides an all-solid-state battery that includes a positive electrode; a negative electrode; and the double-layer solid electrolyte between the positive electrode and negative electrode; wherein the positive electrode is disposed on the solid electrolyte for the positive electrode of the double-layer solid electrolyte, and the negative electrode is disposed on the solid electrolyte for the negative electrode of the double-layer solid electrolyte.

Another embodiment provides a device including the all-solid-state battery, and the device may be a communication device, a transportation device, or an energy storage device.

Another embodiment provides an electric device including the all-solid-state battery, and the electric device may be an electric vehicle, a hybrid electric vehicle, a plug-in hybrid electric vehicle, or an electric power storage device.

The lithium halide-based nanocomposite may provide an electrolyte that has excellent atmospheric stability as a nanosized compound selected from M¹O_{c}, LiX, and a combination thereof is dispersed in the halide compound, has improved ionic conductivity by activating an interface conduction phenomenon, and can significantly improve an interfacial stability and high-potential cycle stability with a sulfide-based solid electrolyte.

### BRIEF DESCRIPTION OF THE DRAWINGS

FIG. 1 is a cross-sectional view of an all-solid-state battery according to an embodiment.

FIGS. 2 and 3 are graphs showing the results of X-ray diffraction (XRD) analysis of products prepared in each step (first step and second step) in Synthesis Examples 1-1 and 1-2, respectively.

FIG. 4 is a graph showing the results of X-ray diffraction analysis of the lithium halide-based composite prepared in Comparative Synthesis Example 1 and the lithium halide-based nanocomposite prepared in Synthesis Example 2-3.

FIG. 5 is a graph showing the results of X-ray diffraction analysis of lithium halide-based nanocomposites prepared in Synthesis Examples 3-1 and 3-2.

FIG. 6 is a graph showing the impedance measurement results of lithium halide-based composites prepared in Comparative Synthesis Example 1 and lithium halide-based nanocomposites prepared in Synthesis Example 2-3.

FIG. 7 is a graph showing the impedance measurement results of the lithium halide-based nanocomposites prepared in Synthesis Example 3-1 and Synthesis Example 3-2.

FIG. 8 is a graph showing the evaluation results of cyclic voltammetry for the lithium halide-based nanocomposite (ZrO₂-2Li₂ZrCl₅F) according to Synthesis Example 2-3 and the lithium halide-based composite (Li₂ZrCl₆) according to Comparative Synthesis Example 1.

FIG. 9 is a graph showing life characteristics at 30° C. of the all-solid-state battery cells according to Comparative Example 1A and Examples 2-3A.

FIG. 10 is a graph showing cycle-life characteristics at 60° C. of the all-solid-state battery cells according to Comparative Example 1A and Examples 2-3A.

FIG. 11 is a graph showing cycle-life characteristics at 60° C. of the all-solid-state battery cell according to Example 2-3B.

### DETAILED DESCRIPTION OF THE EMBODIMENTS

Hereinafter, embodiments will be described in detail so that those skilled in the art can easily implement them. However, a structure actually applied may be implemented in many different forms and is not limited to the implementation described herein.

In the drawings, the thickness of layers, films, panels, regions, etc., are exaggerated for clarity. It will be understood that when an element such as a layer, film, region, or substrate is referred to as being “on” another element, it may be directly on the other element or intervening elements may also be present. In contrast, when an element is referred to as being “directly on” another element, there are no intervening elements present.

In the drawings, parts having no relationship with the description are omitted for clarity of the embodiments, and the same or similar constituent elements are indicated by the same reference numerals throughout the specification.

Hereinafter, the terms “lower” and “upper” are used for better understanding and ease of description, but do not limit the position relationship.

As used herein, “size” means an average particle diameter in the case of a sphere and the length of the longest portion in the case of a non-spherical shape. In addition, the size may be measured by a method well known to those skilled in the art, for example, may be measured by a particle size analyzer, or may be measured by a transmission electron micrograph or a scanning electron micrograph.

In the present inventive concepts, the term “or” is not to be construed as an exclusive meaning, and for example, “A or B” is construed to include A, B, A+B, and/or the like.

As used herein, “at least one of A, B, or C,” “one of A, B, C, or any combination thereof” and “one of A, B, C, and any combination thereof” refer to each constituent element, and any combination thereof (e.g., A; B; C; A and B; A and C; B and C; or A, B, and C).

It will be understood that elements and/or properties thereof may be recited herein as being “the same” or “equal” as other elements, and it will be further understood that elements and/or properties thereof recited herein as being “identical” to, “the same” as, or “equal” to other elements may be “identical” to, “the same” as, or “equal” to or “substantially identical” to, “substantially the same” as or “substantially equal” to the other elements and/or properties thereof. While the term “same,” “equal” or “identical” may be used in description of some example embodiments, it should be understood that some imprecisions may exist. Thus, when one element is referred to as being the same as another element, it should be understood that an element or a value is the same as another element within a desired manufacturing or operational tolerance range (e.g., ±10%).

When the term “about” is used in this specification in connection with a numerical value, it is intended that the associated numerical value includes a manufacturing or operational tolerance (e.g., ±10%) around the stated numerical value. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

Hereinafter, unless otherwise defined, “metal” includes a metal and a semimetal.

Hereinafter, a lithium halide-based nanocomposite according to an embodiment is described.

As described above, the existing lithium ion battery has a stability problem due to frequent fire events due to a use of an ignitable organic liquid electrolyte. Accordingly, research is being conducted to solve stability problem by replacing the organic liquid electrolyte with a halide-based solid electrolyte, which is an inorganic solid electrolyte that is not ignitable, and to increase ionic conductivity at the same time.

Therefore, the present invention has been completed by confirming that in order to improve low ionic conductivity and high interfacial resistance of existing halide-based solid electrolytes, a nanosized compound selected from M¹O_{c}, LiX, and a combination thereof is dispersed in a halide compound to form a nanocomposite, thereby improving atmospheric stability and significantly improving interfacial stability and high-potential cycle stability with a sulfide-based solid electrolyte while improving ionic conductivity due to activation of an interfacial conduction phenomenon.

A lithium halide-based nanocomposite according to an embodiment is represented by any one of Chemical Formulas 1A to 1C, in which a nanosized compound selected from M¹O_{c}, LiX, and a combination thereof is dispersed in a halide compound of LiₐM^{z}X_{b}.

M¹O_{c}—LiₐM²X_{b} [Chemical Formula 1A]

In Chemical Formula 1A, M¹ and M² are different from each other and are each independently one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X is Cl, Br, F, or I, and a, b, and c are each independently in the range of 0.01 to 10.

LiX—LiₐM²X_{b} [Chemical Formula 1B]

In Chemical Formula 1B, M² is one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X is Cl, Br, F, or I, and a and b are each independently in the range of 0.01 to 10.

M¹O_{c}—LiX—LiₐM²X_{b} [Chemical Formula 1C]

In Chemical Formula 1C, M¹ and M² are different from each other and are each independently one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X is Cl, Br, F, or I, and a, b, and c are each independently in the range of 0.01 to 10.

In LiₐM²X_{b} of Chemical Formulas 1A to 1C, X_{b} may be X¹_{b-d}X²_{d} wherein X¹ and X² may be different from each other and may each independently be Cl, Br, F, or I, b may be in the range of 0.01 to 10, and d may be in the range of 0.01 to 4.

In LiₐM²X_{b} of Chemical Formulas 1A to 1C, X_{b} may be Cl_{b-d}F_{d} or Cl_{b-d}I_{d}, b may be in the range of 0.01 to 10, and d may be the range of 0.01 to 4.

In Chemical Formulas 1A to 1C, M¹ may be Mg, Zr, Si, Sn, Al, or Y, M² may be Zr, Y or Mg, X may be Cl, and a, b, and c may each independently be an integer of 1 to 10. For example, specific examples of the lithium halide-based nanocomposite represented by Chemical Formula 1A may be one or more selected from Al₂O₃-Li₂ZrCl₆, Y₂O₃-Li₂ZrCl₆, ZrO₂-Li₃YCl₆, SiO₂-Li₂ZrCl₆, and SnO₂-Li₂ZrCl₆, and for example, specific examples of the lithium halide-based nanocomposite represented by Chemical Formula 1B may be LiF—Li₂ZrCl₆ or LiCl—Li₂ZrCl₆, and specific examples of the lithium halide-based nanocomposite represented by Chemical Formula 1C include LiCl—Al₂O₃—Li₂ZrCl₆, LiCl—SiO₂-Li₂ZrCl₆, and LiCl—SnO₂-Li₂ZrCl₆.

The lithium halide-based nanocomposite represented by Chemical Formula 1A may include about 1 to about 20 vol % of M¹O_{c} and about 80 to about 99 vol % of LiₐM²X_{b}, for example about 6 to about 9 vol % of M¹O_{c} and about 91 to about 94 vol % of LiₐM²X_{b}, or for example about 7 to about 8 vol % of M¹O_{c} and about 92 to about 93 vol % of LiₐM²X_{b}. For example, the M¹O_{c} may be included in an amount of greater than or equal to about 1 vol %, greater than or equal to about 2 vol %, greater than or equal to about 3 vol %, greater than or equal to about 4 vol %, greater than or equal to about 5 vol %, greater than or equal to about 6 vol %, or greater than or equal to about 7 vol % and less than or equal to about 20 vol %, less than or equal to about 19 vol %, less than or equal to about 18 vol %, less than or equal to about 17 vol %, less than or equal to about 16 vol %, less than or equal to about 15 vol %, less than or equal to about 14 vol %, less than or equal to about 13 vol %, less than or equal to about 12 vol %, less than or equal to about 11 vol %, less than or equal to about 10 vol %, less than or equal to about 9 vol %, less than or equal to about 8 vol %, or less than or equal to about 7 vol %, and the LiₐM²X_{b} may be included in an amount of greater than or equal to about 80 vol %, greater than or equal to about 81 vol %, greater than or equal to about 82 vol %, greater than or equal to about 83 vol %, greater than or equal to about 84 vol %, greater than or equal to about 85 vol %, greater than or equal to about 86 vol %, greater than or equal to about 87 vol %, greater than or equal to about 88 vol %, greater than or equal to about 89 vol %, greater than or equal to about 90 vol %, or greater than or equal to about 91 vol % and less than or equal to about 99 vol %, less than or equal to about 98 vol %, less than or equal to about 97 vol %, less than or equal to about 96 vol %, less than or equal to about 95 vol %, less than or equal to about 94 vol %, or less than or equal to about 93 vol %, or a combination thereof. Within these ranges, a sufficient interfacial ion conductive phase may be provided and improved ionic conductivity may be secured.

The lithium halide-based nanocomposite represented by Chemical Formula 1B may include about 6 to about 34 vol % of LiX and about 66 to about 94 vol % of LiₐM²X_{b}, for example, about 7 to about 9 vol % of LiX and about 91 to about 93 vol % of LiₐM²X_{b}. For example, the LiX may be included in an amount of greater than or equal to about 6 vol %, greater than or equal to about 7 vol %, or greater than or equal to about 8 vol % and less than or equal to about 34 vol %, less than or equal to about 33 vol %, less than or equal to about 32 vol %, less than or equal to about 31 vol %, less than or equal to about 30 vol %, less than or equal to about 29 vol %, less than or equal to about 28 vol %, less than or equal to about 27 vol %, less than or equal to about 26 vol %, less than or equal to about 25 vol %, less than or equal to about 24 vol %, less than or equal to about 23 vol %, less than or equal to about 22 vol %, less than or equal to about 21 vol %, less than or equal to about 20 vol %, less than or equal to about 19 vol %, less than or equal to about 18 vol %, less than or equal to about 17 vol %, less than or equal to about 16 vol % or less than or equal to about 15 vol % and the LiₐM²X_{b} may be included in an amount of greater than or equal to about 66 vol %, greater than or equal to about 67 vol %, greater than or equal to about 68 vol %, greater than or equal to about 69 vol %, greater than or equal to about 70 vol %, greater than or equal to about 71 vol %, greater than or equal to about 72 vol %, greater than or equal to about 73 vol %, greater than or equal to about 74 vol %, greater than or equal to about 75 vol %, greater than or equal to about 76 vol %, greater than or equal to about 77 vol %, greater than or equal to about 78 vol %, greater than or equal to about 79 vol %, greater than or equal to about 80 vol %, greater than or equal to about 85 vol %, or greater than or equal to about 90 vol % and less than or equal to about 94 vol %, less than or equal to about 93 vol %, or less than or equal to about 92 vol %, or a combination thereof.

Within these ranges, a sufficient interfacial ion conductive phase may be provided and improved ionic conductivity may be secured.

The lithium halide-based nanocomposite represented by Chemical Formula 1C may include about 1 to about 13 vol % of M¹O_{c}, about 1 to about 29 vol % of LiX, and about 65 to about 94 vol % of LiₐM²X_{b}, for example about 2 to about 12 vol % of M¹O_{c}, about 2 to about 25 vol % of LiX, and about 66 to about 93 vol % of LiₐM²X_{b}, for example about 5 to about 12 vol % of M¹O_{c}, about 2 to about 25 vol % of LiX, and about 66 to about 93 vol % of LiₐM²X_{b}, or for example about 8 to about 12 vol % of M¹O_{c}, about 21 to about 25 vol % of LiX, and about 66 to about 68 vol % of LiₐM²X_{b}. For example, the M¹O_{c} may be included in an amount of greater than or equal to about 1 vol %, greater than or equal to about 2 vol %, greater than or equal to about 3 vol %, greater than or equal to about 4 vol %, greater than or equal to about 5 vol %, greater than or equal to about 6 vol %, greater than or equal to about 7 vol %, or greater than or equal to about 8 vol % and less than or equal to about 13 vol %, less than or equal to about 12 vol %, less than or equal to about 11 vol %, or less than or equal to about 10 vol %, the LiX may be included in an amount of greater than or equal to about 1 vol %, greater than or equal to about 2 vol %, greater than or equal to about 3 vol %, greater than or equal to about 4 vol %, greater than or equal to about 5 vol %, greater than or equal to about 6 vol %, greater than or equal to about 7 vol %, greater than or equal to about 8 vol %, greater than or equal to about 9 vol %, greater than or equal to about 10 vol %, greater than or equal to about 15 vol %, or greater than or equal to about 20 vol % and less than or equal to about 29 vol %, less than or equal to about 28 vol %, less than or equal to about 27 vol %, less than or equal to about 26 vol %, or less than or equal to about 25 vol %, and the LiₐM²X_{b} may be included in an amount of greater than or equal to about 65 vol % or greater than or equal to about 66 vol % and less than or equal to about 94 vol %, less than or equal to about 93 vol %, less than or equal to about 92 vol %, less than or equal to about 91 vol %, less than or equal to about 90 vol %, less than or equal to about 85 vol %, less than or equal to about 80 vol %, less than or equal to about 75 vol %, or less than or equal to about 70 vol %, or a combination thereof. Within these ranges, a sufficient interfacial ion conductive phase may be provided and improved ionic conductivity may be secured.

A lithium halide-based nanocomposite according to another embodiment is represented by any one of Chemical Formulas 2A to 2C, in which a nanosized compound selected from M¹O_{c}, LiX, and a combination thereof is dispersed in a halide compound of LiₐM²X¹_{b-d}X²_{d}.

M¹O_{c}—LiₐM²X¹_{b-d}X²_{d} [Chemical Formula 2A]

In Chemical Formula 2A, M¹ and M² are the same or different, and are each independently one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X¹ and X² are different from each other and are each independently Cl, Br, F, or I, a, b, and c are each independently in the range of 0.01 to 10, and d is in the range of 0.01 to 4.

LiX—LiₐM²X¹_{b-d}X²_{d} [Chemical Formula 2B]

In Chemical Formula 2B, M² is one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X is Cl, Br, F, or I, X¹ and X² are different from each other and are each independently Cl, Br, F, or I, a and b are each independently in the range of 0.01 to 10, and d is in the range of 0.01 to 4.

M¹O_{c}—LiX—LiₐM²X¹_{b-d}X²_{d} [Chemical Formula 2C]

In Chemical Formula 2C, M¹ and M² are each independently one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X is Cl, Br, F, or I, X¹ and X² are different from each other and are each independently Cl, Br, F, or I, a, b, and c are each independently in the range of 0.01 to 10, and d is in the range of 0.01 to 4.

LiₐM²X¹_{b-d}X²_{d} in Chemical Formulas 2A to 2C may be LiₐM²Cl_{b-d}F_{d} or LiₐM²Cl_{b-d}I_{d} wherein a and b may be in the range of 0.01 to 10, and d may be in the range of 0.01 to 4.

In LiₐM²X¹_{b-d}X²_{d} of Chemical Formulas 2A to 2C, a portion of M² may be substituted with M³ to be a compound represented by LiₐM²₁₋ₑM³ₑX¹_{b-d}X²_{d}, wherein M², X¹, X², a, b, and d are the same as in Chemical Formulas 2A to 2C, and M³ may be the same as or different from M¹ and may be one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, and e may be in the range of 0.01 to 0.9.

In Chemical Formulas 2A to 2C, M¹ may be Zr, Mg, Al, or Y, M² may be Zr, Mg, Y, or In, and a, b, and c may each independently be in the range of 0.01 to 10. For example, specific examples of the lithium halide-based nanocomposite represented by Chemical Formulas 2A to 2C may include ZrO₂-Li₂ZrCl₅F, ZrO₂—Li₂ZrCl_{4.5}F₁₅, ZrO₂-Li₂ZrCl₄F₂, ZrO₂—LiF—Li₂ZrCl₅F, Al₂O₃-Li₂ZrCl₅F.

The lithium halide-based nanocomposite represented by Chemical Formula 2A may include about 1 to about 20 vol % of M¹O_{c} and about 80 to about 99 vol % of LiₐM²X¹_{b-d}X²_{d}, for example, about 6 to about 9 vol % of M¹O_{c} and about 91 to about 94 vol % of LiₐM²X¹_{b-d}X²_{d}, or for example, about 7 to about 8 vol % of M¹O_{c} and about 92 to about 93 vol % of LiₐM²X¹_{b-d}X²_{d}. For example, the M¹O_{c} may be included in an amount of greater than or equal to about 1 vol %, greater than or equal to about 2 vol %, greater than or equal to about 3 vol %, greater than or equal to about 4 vol %, greater than or equal to about 5 vol %, greater than or equal to about 6 vol %, or greater than or equal to about 7 vol % and less than or equal to about 20 vol %, less than or equal to about 19 vol %, less than or equal to about 18 vol %, less than or equal to about 17 vol %, less than or equal to about 16 vol %, less than or equal to about 15 vol %, less than or equal to about 14 vol %, less than or equal to about 13 vol %, less than or equal to about 12 vol %, less than or equal to about 11 vol %, less than or equal to about 10 vol %, less than or equal to about 9 vol %, less than or equal to about 8 vol %, or less than or equal to about 7 vol %, and the LiₐM²X¹_{b-d}X²_{d} may be included in an amount of greater than or equal to about 80 vol %, greater than or equal to about 81 vol %, greater than or equal to about 82 vol %, greater than or equal to about 83 vol %, greater than or equal to about 84 vol %, greater than or equal to about 85 vol %, greater than or equal to about 86 vol %, greater than or equal to about 87 vol %, greater than or equal to about 88 vol %, greater than or equal to about 89 vol %, greater than or equal to about 90 vol %, or greater than or equal to about 91 vol % and less than or equal to about 99 vol %, less than or equal to about 98 vol %, less than or equal to about 97 vol %, less than or equal to about 96 vol %, less than or equal to about 95 vol %, less than or equal to about 94 vol % or less than or equal to about 93 vol %, or a combination thereof. Within these ranges, a sufficient interfacial ion conductive phase may be provided and improved ionic conductivity may be secured.

The lithium halide-based nanocomposite represented by Chemical Formula 2B may include about 6 to about 34 vol % of LiX and about 66 to about 94 vol % of LiₐM²X¹_{b-d}X²_{d}, or for example, about 7 to about 9 vol % of LiX and about 91 to about 93 vol % of LiₐM²X¹_{b-d}X²_{d}. For example, the LiX may be included in an amount of greater than or equal to about 6 vol %, greater than or equal to about 7 vol %, or greater than or equal to about 8 vol % and less than or equal to about 34 vol %, less than or equal to about 33 vol %, less than or equal to about 32 vol %, less than or equal to about 31 vol %, less than or equal to about 30 vol %, less than or equal to about 29 vol %, less than or equal to about 28 vol %, less than or equal to about 27 vol %, less than or equal to about 26 vol %, less than or equal to about 25 vol %, less than or equal to about 24 vol %, less than or equal to about 23 vol %, less than or equal to about 22 vol %, less than or equal to about 21 vol %, less than or equal to about 20 vol %, less than or equal to about 19 vol %, less than or equal to about 18 vol %, less than or equal to about 17 vol %, less than or equal to about 16 vol %, or less than or equal to about 15 vol %, and the LiₐM²X¹_{b-d}X²_{d} may be included in an amount of greater than or equal to about 66 vol %, greater than or equal to about 67 vol %, greater than or equal to about 68 vol %, greater than or equal to about 69 vol %, greater than or equal to about 70 vol %, greater than or equal to about 71 vol %, greater than or equal to about 72 vol %, greater than or equal to about 73 vol %, greater than or equal to about 74 vol %, greater than or equal to about 75 vol %, greater than or equal to about 76 vol %, greater than or equal to about 77 vol %, greater than or equal to about 78 vol %, greater than or equal to about 79 vol %, greater than or equal to about 80 vol %, greater than or equal to about 85 vol %, or greater than or equal to about 90 vol % and less than or equal to about 94 vol %, less than or equal to about 93 vol %, or less than or equal to about 92 vol %, or a combination thereof. Within these ranges, a sufficient interfacial ion conductive phase may be provided and improved ionic conductivity may be secured.

The lithium halide-based nanocomposite represented by Chemical Formula 2C may include about 1 to about 13 vol % of M¹O_{c}, about 1 to about 29 vol % of LiX, and about 65 to about 94 vol % of LiₐM²X¹_{b-d}X²_{d}, for example, about 2 to about 12 vol % of M¹O_{c}, about 2 to about 25 vol % of LiX, and about 66 to about 93 vol % of LiₐM²X¹_{b-d}X²_{d}, for example about 5 to about 12 vol % of M¹O_{c}, about 2 to about 25 vol % of LiX, and about 66 to about 93 vol % of LiₐM²X¹_{b-d}X²_{d}, or for example, about 8 to about 12 vol % of M¹O_{c}, about 21 to about 25 vol % of LiX, and about 66 to about 68 vol % of LiₐM²X¹_{1-d}X²_{d}. For example, the M¹O_{c} may be included in an amount of greater than or equal to about 1 vol %, greater than or equal to about 2 vol %, greater than or equal to about 3 vol %, greater than or equal to about 4 vol %, greater than or equal to about 5 vol %, greater than or equal to about 6 vol %, greater than or equal to about 7 vol %, or greater than or equal to about 8 vol % and less than or equal to about 13 vol %, less than or equal to about 12 vol %, less than or equal to about 11 vol %, or less than or equal to about 10 vol %, the LiX may be included in an amount of greater than or equal to about 1 vol %, greater than or equal to about 2 vol %, greater than or equal to about 3 vol %, greater than or equal to about 4 vol %, greater than or equal to about 5 vol %, greater than or equal to about 6 vol %, greater than or equal to about 7 vol %, greater than or equal to about 8 vol %, greater than or equal to about 9 vol %, greater than or equal to about 10 vol %, greater than or equal to about 15 vol %, or greater than or equal to about 20 vol % and less than or equal to about 29 vol %, less than or equal to about 28 vol %, less than or equal to about 27 vol %, less than or equal to about 26 vol %, or less than or equal to about 25 vol %, and the LiₐM²X¹_{b-d}X²_{d} may be included in an amount of greater than or equal to about 65 vol % or greater than or equal to about 66 vol % and less than or equal to about 94 vol %, less than or equal to about 93 vol %, less than or equal to about 92 vol %, less than or equal to about 91 vol %, less than or equal to about 90 vol %, less than or equal to about 85 vol %, less than or equal to about 80 vol %, less than or equal to about 75 vol %, or less than or equal to about 70 vol % or a combination thereof. Within these ranges, a sufficient interfacial ion conductive phase may be provided and improved ionic conductivity may be secured.

Another embodiment provides a lithium halide-based nanocomposite represented by any one of Chemical Formulas 3A to 3C, in which a nanosized compound selected from M¹O_{c}, LiX, and a combination thereof is dispersed in a halide compound of LiₐM²₁₋ₑM³ₑX_{b}.

M¹O_{c}—LiₐM²₁₋ₑM³ₑX_{b} [Chemical Formula 3A]

In Chemical Formula 3A, M¹, M², and M³ are each independently one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X is Cl, Br, F, or I, M² and M³ are different from each other, a, b, and c are each independently in the range of 0.01 to 10, and e is in the range of 0.01 to 0.9.

LiX—LiₐM²₁₋ₑM³ₑX_{b} [Chemical Formula 3B]

In Chemical Formula 3B, M² and M³ are different from each other and are each independently one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X is Cl, Br, F, or I, a and b are each independently in the range of 0.01 to 10, and e is in the range of 0.01 to 0.9.

M¹O_{c}—LiX—LiₐM²₁₋ₑM³ₑX_{b} [Chemical Formula 3C]

In Chemical Formula 3C, M¹, M², and M³ are each independently one or more selected from Mg, Ca, Zn, Cd, Cu, Sc, Y, B, Al, Ga, In, Ln (La, Ce, Pr, Nd, Pm, Sm, Eu, Gd, Tb, Dy, Ho, Er, Yb, or Lu), Ti, Zr, Hf, Nb, Ta, Mo, W, Sb, Si, Ge, Sn, V, Cr, Mn, Fe, Co, and Ni, X is Cl, Br, F, or I, a, b, and c are each independently in the range of 0.01 to 10, and e is in the range of 0.01 to 0.9.

In LiₐM²₁_ₑM³ₑX_{b} of Chemical Formulas 3A to 3C, X_{b} may be X¹_{b-d}X²_{d} wherein X¹ and X² may be different from each other and may each independently be Cl, Br, F, or I, b may be in the range of 0.01 to 10, and d may be in the range of 0.01 to 4.

In LiₐM²₁₋ₑM³ₑX_{b} of Chemical Formulas 3A to 3C, X_{b} may be Cl_{b-d}F_{d} or Cl_{b-d}I_{d}, wherein b may be in the range of 0.01 to 10, and d may be in the range of 0.01 to 4.

In Chemical Formulas 3A to 3C, M¹ may be Zr, Mg, Al, or Y, M² may be Zr or Mg, M³ may be Fe or Y, X may be Cl, and a, b, and c may each independently be in the range of 0.01 to 10. For example, specific examples of the lithium halide-based nanocomposite represented by Chemical Formulas 3A to 3C may be ZrO₂—Li₂Zr_{0.9}Fe_{0.1}Cl₆ or ZrO₂-Li₂Zr_{0.75}Y_{0.25}Cl₆.

The lithium halide-based nanocomposite represented by Chemical Formula 3A may include about 1 to about 20 vol % of M¹O_{c} and about 80 to about 99 vol % of LiₐM²₁₋ₑM³ₑX_{b}, for example, about 6 to about 9 vol % of M¹O_{c} and about 91 to about 94 vol % of LiₐM²₁_ₑM³ₑX_{b}, or for example, about 7 to about 8 vol % of M¹O_{c} and about 92 to about 93 vol % of LiₐM²₁₋ₑM³ₑX_{b}. For example, the M¹O_{c} may be included in an amount of greater than or equal to about 1 vol %, greater than or equal to about 2 vol %, greater than or equal to about 3 vol %, greater than or equal to about 4 vol %, greater than or equal to about 5 vol %, greater than or equal to about 6 vol %, or greater than or equal to about 7 vol % and less than or equal to about 20 vol %, less than or equal to about 19 vol %, less than or equal to about 18 vol %, less than or equal to about 17 vol %, less than or equal to about 16 vol %, less than or equal to about 15 vol %, less than or equal to about 14 vol %, less than or equal to about 13 vol %, less than or equal to about 12 vol %, less than or equal to about 11 vol %, less than or equal to about 10 vol %, less than or equal to about 9 vol %, less than or equal to about 8 vol %, or less than or equal to about 7 vol %, and the LiₐM²₁₋ₑM³ₑX_{b} may be included in an amount of greater than or equal to about 80 vol %, greater than or equal to about 81 vol %, greater than or equal to about 82 vol %, greater than or equal to about 83 vol %, greater than or equal to about 84 vol %, greater than or equal to about 85 vol %, greater than or equal to about 86 vol %, greater than or equal to about 87 vol %, greater than or equal to about 88 vol %, greater than or equal to about 89 vol %, greater than or equal to about 90 vol %, or greater than or equal to about 91 vol % and less than or equal to about 99 vol %, less than or equal to about 98 vol %, less than or equal to about 97 vol %, less than or equal to about 96 vol %, less than or equal to about 95 vol %, less than or equal to about 94 vol %, or less than or equal to about 93 vol %, or a combination thereof. Within these ranges, a sufficient interfacial ion conductive phase may be provided and improved ionic conductivity may be secured.

The lithium halide-based nanocomposite represented by Chemical Formula 3B may include about 6 to about 34 vol % of LiX and about 66 to about 94 vol % of LiₐM²₁₋ₑM³ₑX_{b}, or for example, about 7 to about 9 vol % of LiX and about 91 to about 93 vol % of LiₐM²₁₋ₑM³ₑX_{b}. For example, the LiX may be included in an amount of greater than or equal to about 6 vol %, greater than or equal to about 7 vol %, or greater than or equal to about 8 vol % and less than or equal to about 34 vol %, less than or equal to about 33 vol %, less than or equal to about 32 vol %, less than or equal to about 31 vol %, less than or equal to about 30 vol %, less than or equal to about 29 vol %, less than or equal to about 28 vol %, less than or equal to about 27 vol %, less than or equal to about 26 vol %, less than or equal to about 25 vol %, less than or equal to about 24 vol %, less than or equal to about 23 vol %, less than or equal to about 22 vol %, less than or equal to about 21 vol %, less than or equal to about 20 vol %, less than or equal to about 19 vol %, less than or equal to about 18 vol %, less than or equal to about 17 vol %, less than or equal to about 16 vol %, or less than or equal to about 15 vol % and the LiₐM²₁₋ₑM³X_{b} may be included in an amount of greater than or equal to about 66 vol %, greater than or equal to about 67 vol %, greater than or equal to about 68 vol %, greater than or equal to about 69 vol %, greater than or equal to about 70 vol %, greater than or equal to about 71 vol %, greater than or equal to about 72 vol %, greater than or equal to about 73 vol %, greater than or equal to about 74 vol %, greater than or equal to about 75 vol %, greater than or equal to about 76 vol %, greater than or equal to about 77 vol %, greater than or equal to about 78 vol %, greater than or equal to about 79 vol %, greater than or equal to about 80 vol %, greater than or equal to about 85 vol %, or greater than or equal to about 90 vol % and less than or equal to about 94 vol %, less than or equal to about 93 vol %, or less than or equal to about 92 vol %, or a combination thereof. Within these ranges, a sufficient interfacial ion conductive phase may be provided and improved ionic conductivity may be secured.

The lithium halide-based nanocomposite represented by Chemical Formula 3C may include about 1 to about 13 vol % of M¹O_{c}, about 1 to about 29 vol % of LiX, and about 65 to about 94 vol % of LiₐM²₁₋ₑM³ₑX_{b}, for example, about 2 to about 12 vol % of M¹O_{c}, about 2 to about 25 vol % of LiX, and about 66 to about 93 vol % of LiₐM²₁₋ₑM³ₑX_{b}, for example about 5 to about 12 vol % of M¹O_{c}, about 2 to about 25 vol % of LiX, and about 66 to about 93 vol % of LiₐM²₁₋ₑM³ₑX_{b}, or for example about 8 to about 12 vol % of M¹O_{c}, about 21 to about 25 vol % of LiX, and about 66 to about 68 vol % of LiₐM²₁₋ₑM³ₑX_{b}. For example, the M¹O_{c} may be included in an amount of greater than or equal to about 1 vol %, greater than or equal to about 2 vol %, greater than or equal to about 3 vol %, greater than or equal to about 4 vol %, greater than or equal to about 5 vol %, greater than or equal to about 6 vol %, greater than or equal to about 7 vol %, or greater than or equal to about 8 vol % and less than or equal to about 13 vol %, less than or equal to about 12 vol %, less than or equal to about 11 vol %, or less than or equal to about 10 vol %, the LiX may be included in an amount of greater than or equal to about 1 vol %, greater than or equal to about 2 vol %, greater than or equal to about 3 vol %, greater than or equal to about 4 vol %, greater than or equal to about 5 vol %, greater than or equal to about 6 vol %, greater than or equal to about 7 vol %, greater than or equal to about 8 vol %, greater than or equal to about 9 vol %, greater than or equal to about 10 vol %, greater than or equal to about 15 vol %, or greater than or equal to about 20 vol % and less than or equal to about 29 vol %, less than or equal to about 28 vol %, less than or equal to about 27 vol %, less than or equal to about 26 vol %, or less than or equal to about 25 vol %, and the LiₐM²₁₋ₑM³ₑX_{b} may be included in an amount of greater than or equal to about 65 vol % or greater than or equal to about 66 vol % and less than or equal to about 94 vol %, less than or equal to about 93 vol %, less than or equal to about 92 vol %, less than or equal to about 91 vol %, less than or equal to about 90 vol %, less than or equal to about 85 vol %, less than or equal to about 80 vol %, less than or equal to about 75 vol %, or less than or equal to about 70 vol % or a combination thereof. Within these ranges, a sufficient interfacial ion conductive phase may be provided and improved ionic conductivity may be secured.

The lithium halide-based nanocomposite is a composite including a nanosized compound selected from M¹O_{c}, LiX, and a combination thereof and a halide compound (LiₐM²X_{b}, LiₐM²X¹_{b-d}X²_{d}, or LiₐM²₁_ₑM³ₑX_{b}). The “nanosized” means a size of several nanometers to hundreds of nanometers, and specifically means having a size of greater than or equal to about 0.1 nm and less than or equal to about 100 nm, for example, less than or equal to about 50 nm, less than or equal to about 40 nm, less than or equal to about 30 nm, less than or equal to about 20 nm, or less than or equal to about 10 nm. In the above, the size means a diameter in the case of a particle shape and the longest length in the case of an irregular shape. The particle size of the nanosized compound selected from M¹O_{c}, LiX, and the combination thereof may be obtained as a result of transmission electron microscopy (TEM) analysis.

The nanosized compound selected from M¹O_{c}, LiX, and the combination thereof may be located at a grain boundary of a halide compound.

The nanosized compound selected from M¹O_{c}, LiX, and the combination thereof may be in-situ grown into crystalline particles when forming a nanocomposite. These nanosized compounds may be formed in a network (reticular) shape inside a halide compound (LiₐM²X_{b}, LiₐM²X¹_{b-d}X²_{d}, or LiₐM²₁₋ₑM³ₑX_{b}).

By growing the nanosized compound into particles of a certain size or less, aggregation of particles may not occur and improved dispersibility in the halide compound may be maintained. In an embodiment, the nanosized compound may be ZrO₂, and may have an average crystal size of about 5 to about 10 nm.

The nanosized compound (e.g., ZrO₂) may be grown in-situ by mechanical milling of raw materials of the nanocomposite, and may improve ionic conductivity of the nanocomposite by increasing the active interfacial ion conduction, and provide excellent dispersibility and uniformity because agglomeration does not occur. Accordingly, interfacial stability and cycle stability between the sulfide-based solid electrolyte and the halide-based solid electrolyte may be increased.

The nanosized compound and the halide compound of the lithium halide-based nanocomposite may provide high ionic conductivity by generating a space charge layer phenomenon at a solid electrolyte interface. In addition, the lithium halide-based nanocomposite may prevent direct contact between the halide-based solid electrolyte and the sulfide-based solid electrolyte, thereby suppressing a side reaction occurring at the interface in a high-temperature and high-voltage environment, and further improving cycle stability at a high potential.

The lithium halide-based nanocomposite may have an ionic conductivity of about 0.1 to about 5 mS/cm, for example about 0.7 to about 3 mS/cm, about 1.17 to about 2 mS/cm, or about 1.28 to about 1.33 mS/cm at 30° C.

The lithium halide-based nanocomposite shows a crystal phase through X-ray diffraction analysis (XRD) and may have a glass-ceramic crystal structure. The glass-ceramic crystal structure has an X-ray diffraction pattern consistent with the X-ray diffraction result of the hexagonal close-packed (hcp) trigonal Li₂ZrCl₆ (space group: P-3 ml), and there is a possibility of low crystallinity and structural distortion due to the broad peak. In particular, when the volume ratio of lithium halide and metal oxide increases, the X-ray diffraction pattern of the hexagonal close-packed (hcp) trigonal Li₂ZrCl₆ (space group: P-3 ml) decreases and a lithium halide-based X-ray diffraction pattern may be exhibited.

In addition, the lithium halide-based nanocomposite may exhibit a first effective peak and a second effective peak in the ranges of about 0.4 to about 0.6 ppm and about −0.2 to about 0.2 ppm, respectively, in a ⁶Li MAS NMR analysis result, and an intensity ratio of the first effective peak to the second effective peak may be about 0.7 to about 0.8. In particular, the first effective peak means that interfacial lithium ion conduction has occurred.

Hereinafter, a method for preparing a lithium halide-based nanocomposite is described.

The lithium halide-based nanocomposite represented by any one of Chemical Formulas 1A to 1C may be prepared by the following method using compounds in which M¹ and M² are different from each other.

First, a solid-phase reaction of a lithium-containing oxidizing agent and a first metal (M¹)-containing halide is performed under an inert gas atmosphere to obtain first metal (M¹) oxide and a lithium halide, and
a solid-phase reaction of the first metal (M¹) oxide, lithium halide, and second metal (M²)-containing halide is performed to prepare the lithium halide-based nanocomposite represented by any one of Chemical Formulas 1A to 1C.

The lithium-containing oxidizing agent may be a lithium-containing salt and may be selected from Li₂O, Li₂CO₃, Li₂SO₄, and LiNO₃.

The lithium-containing oxidizing agent may function as an oxidizing agent because it contains oxygen. That is, the lithium-containing oxidizing agent reacts with the metal halide to generate metal oxide and lithium halide, and these products form a space charge layer at the interface of the solid electrolyte to improve the ionic conductivity of the lithium halide-based nanocomposite. Furthermore, the metal oxide and the lithium halide prevent direct contact between the halide-based solid electrolyte and the sulfide-based solid electrolyte, thereby suppressing a side reaction at the interface between the halide-based solid electrolyte and the sulfide-based solid electrolyte at high temperature and high voltage.

The first metal (M¹)-containing halide is abundant in the earth's crust and contains an inexpensive element, thereby preparing a low-cost solid electrolyte. The first metal (M¹)-containing halide may be appropriately selected according to the type of the first metal (M¹), and specific examples thereof may be one or more selected from TiCl₄, TiBr₄, ZrCl₄, ZrBr₄, HfCl₄, and HfBr₄.

The lithium halide may be one or more selected from LiCl, LiBr, LiF, and LiI.

When the lithium-containing oxidizing agent is Li₂O, the first metal (M¹)-containing halide is AlCl₃ and the second metal (M²)-containing halide is ZrCl₄, the preparation method may be represented by Reaction Schemes 1A and 1B:

3Li₂O+2AlCl₃→6LiCl+Al₂O₃ [Reaction Scheme 1A]

6aLiC1+aAl₂O₃+bZrCl₄→aAl₂O₃+(6a−2b)LiCl+bLi₂ZrCl₆ [Reaction Scheme 1B]

In Reaction Scheme 1B, a is in the range of 0≤a≤6 and b is in the range of 0≤b≤6.

In Reaction Scheme 1A, Li₂O oxidizes AlCl₃ to form LiCl and in-situ grown Al₂O₃, and Al₂O₃, LiCl, and ZrCl₄ react to form Li₂ZrCl₆. The resulting LiCl, in-situ grown Al₂O₃ and Li₂ZrCl₆ are combined to form a lithium halide-based nanocomposite having an Al₂O₃—LiCl—Li₂ZrCl₆ structure.

When the metal oxides (e.g., Al₂O₃, SiO₂, SnO₂, and ZrO₂) grown in-situ in the lithium halide-based nanocomposite react with the halide-based solid electrolyte, an ionic conductivity may increase at the interface of the solid electrolyte when reacting with a halide-based solid electrolyte and a reactivity is reduced at high voltage when reacting with a sulfide-based solid electrolyte to manufacture an all-solid-state battery having a high energy density. The inert gas may be at least one selected from argon, helium, neon, and nitrogen.

The solid-phase mixing may be performed by any one of mechanical milling selected from ball mill, vibration mill, turbo mill, mechanofusion, and disk mill, and in an embodiment, the solid-phase mixing may be desirably performed by ball mill or vibration mill. The lithium halide-based nanocomposites obtained through such mechanical milling may improve ionic conductivity by about 2 to about 10 times compared to conventional halide-based solid electrolyte materials.

The mechanical milling may be performed for about 10 to about 50 hours at a rotational speed of about 300 to about 800 rpm, for example for about 7 to about 18 hours at a rotational speed of about 500 to about 700 rpm, or for example for about 9 to about 11 hours at a rotational speed of about 580 to about 620 rpm.

A method for preparing the lithium halide-based nanocomposite represented by any one of Chemical Formulas 2A to 2C is as follows.

In the case of the lithium halide-based nanocomposite in which M¹ and M² are the same in Chemical Formulas 2A to 2C, a lithium-containing oxidizing agent; a first halide of the first metal (M¹) or the second metal (M²) and a second halide of the first metal (M¹) or the second metal (M²); and a lithium-containing first halide and a lithium-containing second halide are subjected to a solid-phase reaction under an inert gas atmosphere.

The lithium halide-based nanocomposite in Chemical Formulas 2A to 2C where M¹ and M² are different from each other may be prepared as follows: a lithium-containing oxidizing agent, a first metal (M¹)-containing first halide, and a first metal (M¹)-containing second halide may be subjected to a solid-phase reaction under an inert gas atmosphere to obtain a first metal (M¹) oxide, a lithium-containing first halide, and a lithium-containing second halide; and the first metal (M¹) oxide, lithium-containing first halide, lithium-containing second halide, a second metal (M²)-containing first halide, and a second metal (M²)-containing second halide may be subjected to a solid-phase reaction.

The lithium-containing oxidizing agent, solid-phase mixing, and mechanical milling are as described above.

The first halide of the first metal (M¹) or the second metal (M²) and the second halide of the first metal (M¹) or the second metal (M²) may be the first halide including the first metal (M¹) or the second metal (M²) or the second halide including the first metal (M¹) or the second metal (M²) and may be appropriately selected according to the type of the first metal (M¹) or the second metal (M²).

A method for preparing the lithium halide-based nanocomposite represented by any one of Chemical Formulas 3A to 3C is as follows.

In the case of the lithium halide-based nanocomposite in Chemical Formulas 3A to 3C where M¹ and M² are the same, a lithium-containing oxidizing agent, a first metal (M¹)-containing halide, and a lithium halide are subjected to a solid-phase reaction under an inert gas atmosphere to obtain the lithium halide-based nanocomposite in which M¹ and M² are same in Chemical Formulas 1A to 1C, and
the lithium halide-based nanocomposite and the third metal (M³)-containing halide are subjected to a solid-phase reaction to prepare the lithium halide-based nanocomposite represented by any one of Chemical Formulas 3A to 3C.

In the case of the lithium halide-based nanocomposite in Chemical Formulas 3A to 3C where M¹ and M² are different from each other, a lithium-containing oxidizing agent and a first metal (M¹)-containing halide and optionally a lithium halide are subjected to a solid-phase reaction under an inert gas atmosphere to obtain a first metal (M¹) oxide and a lithium halide, and the first metal (M¹) oxide, lithium halide, and second metal (M²)-containing halide are subjected to a solid-phase reaction to obtain a lithium halide-based nanocomposites in which M¹ and M² are different from each other in Chemical Formulas 1A to 1C, and
the lithium halide-based nanocomposite and the third metal (M³)-containing halide are subjected to a solid-phase reaction to prepare the lithium halide-based nanocomposite represented by any one of Chemical Formulas 3A to 3C.

The lithium-containing oxidizing agent, solid-phase mixing, and mechanical milling are as described above.

The first metal (M¹)-containing halide, second metal (M²)-containing halide, and third metal (M³)-containing halide contain abundant and inexpensive elements in the earth's crust to prepare a low-cost solid electrolyte. The first metal (M¹)-containing halide, the second metal (M²)-containing halide and the third metal (M³)-containing halide may be appropriately selected according to the first metal (M¹), the second metal (M²), and the third metal (M³).

The lithium halide may be at least one selected from LiCl, LiBr, LiF, and LiI.

Hereinafter, a positive electrode active material including the nanocomposite is described.

A positive electrode active material according to an embodiment includes a core including a composite metal oxide capable of reversibly intercalating/deintercalating lithium; and a shell on the core and including the lithium halide-based nanocomposite.

A sulfide-based solid electrolyte has attracted much attention as materials suitable for all-solid-state batteries due to their high ionic conductivity and brittle mechanical properties, but are electrochemically unstable. The sulfide-based solid electrolyte may cause serious side reactions when in direct contact with the 4V-class positive electrode active material. Recently, in order to prevent direct contact between the sulfide-based solid electrolyte and the 4V-class positive electrode active material, research on making an oxide-based solid electrolyte in a shell form for the positive electrode active material is being developed.

However, although the oxide-based solid electrolyte shell can suppress side reactions of the sulfide-based solid electrolyte, it acts as a resistance layer inside the all-solid-state battery due to its low ionic conductivity, causing deterioration in the performance of the all-solid-state battery. In the above embodiment, by replacing the oxide-based solid electrolyte shell with the lithium halide-based nanocomposite shell according to an embodiment to form a positive electrode active material, side reactions between the positive electrode active material and the sulfide-based solid electrolyte may be suppressed and at the same time an internal resistance of the all-solid-state battery may be minimized due to improved ionic conductivity to manufacture an all-solid-state battery with excellent performance.

Provided is a solid electrolyte for a rechargeable lithium battery including the lithium halide-based nanocomposite according to an embodiment and a sulfide-based solid electrolyte.

The sulfide-based solid electrolyte may be Li_{7+x-y}Mₓ⁴⁺M₁₋ₓ⁵⁺S_{6-y}X_{y} (M⁴⁺: Si, Ge, S or Sn; M⁵⁺: P, Sb; X: Cl, Br, or I, 0≤x≤1, and 0≤y≤2), Li₁₀₊ₐ[Ge_{b}M⁴⁺_{1-b}]₁₊ₐP₂ₐS_{12-c}X_{c} (M⁴⁺: Si or Sn; X: Cl, Br, or I, 0≤a≤2, 0≤b≤1, and 0≤c≤4), or a mixture thereof, but is not limited thereto.

A specific example of Li_{7+x-y}Mₓ⁴⁺M₁₋ₓ⁵⁺S_{6-y}X_{y} may be Li₆PS₅Cl, and a specific example of Li₁₀₊ₐ[Ge_{b}M⁴⁺_{1-b}]₁₊ₐP₂ₐS_{12-c}X_{c} may be Li_{9.54}Si_{1.74}P_{1.44}S_{11.7}Cl_{0.3}.

In addition, provided is a double-layer solid electrolyte for a rechargeable lithium battery including a solid electrolyte for a positive electrode including a lithium halide-based nanocomposite according to an embodiment; and a solid electrolyte for a negative electrode disposed on the solid electrolyte for the positive electrode and including a sulfide-based solid electrolyte.

The above-described solid electrolyte includes the halide-based nanocomposites, and thus it has no problem of generating hydrogen sulfide, and has excellent oxidation stability like oxides and may be usefully applied to all-solid-state batteries. In particular, since the double-layer solid electrolyte includes the lithium halide-based nanocomposite, interfacial side reactions between the solid electrolyte for the positive electrode and the solid electrolyte for the negative electrode can be solved in an all-solid-state battery, and excellent cycle stability can be exhibited.

In addition, provided is an all-solid-state battery including a positive electrode; a negative electrode; and the aforementioned solid electrolyte between the positive electrode and negative electrode.

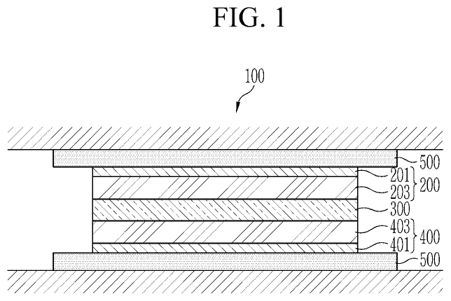

Hereinafter, an all-solid-state battery is described with reference to FIG. 1.

FIG. 1 is a cross-sectional view of an all-solid-state battery according to an embodiment. Referring to FIG. 1, an all-solid-state battery 100 have a structure in which an electrode assembly including a negative electrode 400 including a negative electrode current collector 401 and a negative electrode active material layer 403, a solid electrolyte layer 300, and a positive electrode 200 including positive electrode active material layer 203 and a positive electrode current collector 201 which are stacked and stored in a case such as a pouch. The all-solid-state battery 100 may further include an elastic layer 500 on the outside of at least one of the positive electrode 200 and the negative electrode 400. Although one electrode assembly including a negative electrode 400, a solid electrolyte layer 300, and a positive electrode 200 is shown in FIG. 1, an all-solid-state battery may be manufactured by stacking two or more electrode assemblies.

The solid electrolyte layer 300 may include the lithium halide-based nanocomposite and the sulfide-based solid electrolyte.

An all-solid-state battery according to an embodiment includes a positive electrode; a negative electrode; and the aforementioned double-layer solid electrolyte between the positive electrode and negative electrode, wherein the positive electrode is disposed on the solid electrolyte for the positive electrode of the double-layer solid electrolyte, and the negative electrode is disposed on the solid electrolyte for the negative electrode

The double-layer solid electrolyte may include a solid electrolyte for a positive electrode including the lithium halide-based nanocomposite; and a solid electrolyte for a negative electrode disposed on the solid electrolyte for a positive electrode and including a sulfide-based solid electrolyte of the double-layer solid electrolyte.

Also, as a device including an all-solid-state battery according to an embodiment, the device may be any one selected from a communication device, a transportation device, and an energy storage device.

Also, as an electric device including an all-solid-state battery according to an embodiment, the electric device may be one selected from electric vehicles, hybrid electric vehicles, plug-in hybrid electric vehicles, and power storage devices.

The metal oxide (e.g., Al₂O₃) grown in-situ in the lithium halide-based nanocomposite increases ionic conductivity at the interface of the solid electrolyte when reacting with a halide-based solid electrolyte, and decreases reactivity at high voltage when reacting with a sulfide-based solid electrolyte, resulting in providing an all-solid-state battery having a high energy density.

The inert gas may be at least one selected from argon, helium, neon, and nitrogen, and in an embodiment, argon or helium may be desirable, or argon may be more desirable.

The solid-phase mixing may be performed by any one mechanical milling selected from ball mill, vibration mill, turbo mill, mechanofusion and disc mill, desirably a ball mill or a vibration mill, and more desirably a ball mill. The halide-based nanocomposite obtained through such mechanical milling can improve ionic conductivity by about 2 to 10 times compared to conventional halide-based solid electrolyte materials.

The mechanical milling may be performed for about 10 to about 50 hours at a rotational speed of about 300 to about 800 rpm, desirably for about 7 to about 18 hours at a rotational speed of about 500 to about 700 rpm, and more desirably for about 9 to about 11 hours at a rotational speed of about 580 to about 620 rpm.

Hereinafter, various examples and experimental examples of the present invention will be described in detail. However, the following examples are merely some examples of the present invention, and the present invention should not be construed as being limited to the following examples.

### Synthesis Examples 1-1 to 1-9: Preparation of Lithium Halide-Based Nanocomposite Represented by any One of Chemical Formulas 1A to 1C and Measurement of Ionic Conductivity

A lithium-containing oxidizing agent (A) and first metal halide precursor (B) were put in a mole ratio (A:B) shown in Table 1 and then, mechanically milled by using Pulverisette 7 PL (Fritsch GmbH) under an Ar atmosphere in a 50 ml ZrO₂ vial with 15 ZrO₂ balls (Φ=10 mm) at 600 rpm for 20 hours, preparing a first metal oxide (C1) and a lithium halide (C2) (first step).

The first metal oxide (C1), the lithium halide (C2), and a second metal halide precursor (D) were put in a mole ratio ((C1+C2):D) shown in Table 1 and then, mechanically milled by using Pulverisette 7 PL (Fritsch GmbH) under the Ar atmosphere in a 50 ml ZrO₂ vial with 15 ZrO₂ balls (Φ=10 mm) at 600 rpm for 20 hours, preparing a lithium halide-based nanocomposite represented by one of Chemical Formulae 1A to 1C (second step). The prepared lithium halide-based nanocomposites are shown in Table 1.

TABLE 1

| | First step | | | Second step | | | |
|---|---|---|---|---|---|---|---|
| | Lithium- | | | First metal | Second | | |
| | containing | First metal | | oxide (C1) | metal | | |
| | oxidizing | halide | A:B | and lithium | halide | | Lithium |
| | agent | precursor | mole | halide | precursor | (C1 + C2): | halide-based |
| | (A) | (B) | ratio | (C2) | (D) | D | nanocomposite |
| Synthesis | Li₂O | MgCl₂ | 1:1 | 2LiCl + MgO | ZrCl₄ | 1:1 | MgO—Li₂ZrCl₆ |
| Example 1-1 | | | | | | | |
| Synthesis | Li₂O | MgCl₂ | 3:1 | 2LiCl + MgO | ZrCl₄ | 1:1 | LiCl—ZrO₂—Li₂MgCl₄ |
| Example 1-1A | | | | | | | |
| Synthesis | Li₂O | AlCl₃ | 3:2 | 6LiCl + Al₂O₃ | ZrCl₄ | 1:3 | Al₂O₃—3Li₂ZrCl₆ |
| Example 1-2 | | | | | | | |
| Synthesis | Li₂O | AlCl₃ | 3:2 | 6LiCl + Al₂O₃ | ZrCl₄ | 1.5:3 | 3LiCl—1.5Al₂O₃— |
| Example 1-3 | | | | | | | 3Li₂ZrCl₆ |
| Synthesis | Li₂O | AlCl₃ | 3:2 | 6LiCl + Al₂O₃ | YCl₃ | 1:2 | Al₂O₃—2Li₃YCl₆ |
| Example 1-4 | | | | | | | |
| Synthesis | Li₂O | AlCl₃ | 3:2 | 6LiCl + Al₂O₃ | ZrCl₄ | 1:3 | Al₂O₃—3Li₂ZrCl₆ |
| Example 1-5 | | | | | | | |
| Synthesis | Li₂O | ZrCl₄ | 2:1 | 4LiCl + ZrO₂ | YCl₃ | 3:4 | 3ZrO₂—4Li₃YCl₆ |
| Example 1-6 | | | | | | | |
| Synthesis | Li₂O | ZrCl₄ | 2:1 | 4LiCl + ZrO₂ | ZrCl₄ | 1:2 | ZrO₂—2Li₂ZrCl₆ |
| Example 1-7 | | | | | | | |
| Synthesis | Li₂O | SiCl₄ | 2:1 | 4LiCl + SiO₂ | ZrCl₄ | 1:2 | SiO₂—2Li₂ZrCl₆ |
| Example 1-8 | | | | | | | |
| Synthesis | Li₂O | SnCl₄ | 2:1 | 4LiCl + SnO₂ | ZrCl₄ | 1:2 | SnO₂—2Li₂ZrCl₆ |
| Example 1-9 | | | | | | | |

The lithium halide-based nanocomposites according to Synthesis Examples 1-1 to 1-9 were measured with respect to ionic conductivity in the following method. In a glove box under an argon atmosphere, each sample was weighed and placed in a polyetheretherketone tube (a PEEK tube with an interior diameter of 13 mm, an exterior diameter of 32 mm, and a height of 10 mm) and the PEEK tube was inserted so that upper and lower portions of the PEEK tube contact a powder-molding jig containing Ti. Subsequently, the samples were pressed into pellets with a diameter of 13 mm and any thickness at a molding pressure of about 370 MPa by using a single screw press. Then, the obtained pellets were placed in a sealed electrochemical cell capable of maintaining the argon atmosphere.

The ionic conductivity was measured by using an impedance/gain phase analyzer (SP-300, BioLogic) as a frequency response analyzer (FRA) and a small environmental tester as a constant temperature device. The measurement was started from a high frequency region at an AC voltage of 10 mV to 100 mV within a frequency range of 10 Hz to 7 MHz at a temperature of 30° C.

Herein, the results of Synthesis Examples 1-2 to 1-9 are shown in Table 2.

TABLE 2

| | Lithium halide-based | Ionic conductivity |
|---|---|---|
| | nanocomposite | (mS cm⁻¹) |
| Synthesis Example 1-2 | Al₂O₃—3Li₂ZrCl₆ | 0.88 |
| Synthesis Example 1-3 | 3LiCl—1.5Al₂O₃—3Li₂ZrCl₆ | 0.72 |
| Synthesis Example 1-4 | Al₂O₃—2Li₃YCl₆ | 0.52 |
| Synthesis Example 1-5 | Al₂O₃—3Li₂ZrCl₆ | 0.90 |
| Synthesis Example 1-6 | 3ZrO₂—4Li₃YCl₆ | 0.50 |
| Synthesis Example 1-7 | ZrO₂—2Li₂ZrCl₆ | 0.56 |
| Synthesis Example 1-8 | SiO₂—2Li₂ZrCl₆ | 1.47 |
| Synthesis Example 1-9 | SnO₂—2Li₂ZrCl₆ | 1.54 |

Referring to Table 2, the lithium halide-based nanocomposites according to Synthesis Examples 1-2 to 1-9 exhibited improved ionic conductivity.

### Synthesis Examples 2-1 to 2-5: Preparation of Lithium Halide-Based Nanocomposite Represented by any One of Chemical Formulas 2A to 2C and Measurement of Ionic Conductivity

A metal halide precursor was added to a lithium-containing oxidizing agent in a mole ratio shown in Table 3 and mechanically milled by using Pulverisette 7 PL (Fritsch GmbH) under an Ar atmosphere in a 50 ml ZrO₂ vial with 15 ZrO₂ balls (ϕ=10 mm) at 600 rpm for 20 hours, preparing each lithium halide-based nanocomposite represented by Chemical Formulas 2A to 2C. The prepared lithium halide-based nanocomposites are shown in Table 3. For comparison, lithium halide-based composites having each composition of Comparative Synthesis Examples 1 and 2-1 to 2-4 are described.

TABLE 3

| | | | | | | Lithium halide-based |
|---|---|---|---|---|---|---|
| | | | | | | composite or lithium |
| | Precursors (mole ratio) | | | | | halide-based |
| | LiCl | LiF | Li₂O | ZrCl₄ | ZrF₄ | nanocomposite |
| Comparative Synthesis | 2 | — | — | 1 | — | Li₂ZrCl₆ |
| Example 1 | | | | | | |
| Comparative Synthesis | 1 | 1 | — | 1 | — | Li₂ZrCl₅F |
| Example 2-1 | | | | | | |
| Comparative Synthesis | 2 | — | — | 0.75 | 0.25 | Li₂ZrCl₅F |
| Example 2-2 | | | | | | |
| Comparative Synthesis | 0.50 | 1.50 | — | 1 | — | Li₂ZrCl_{4.5}F_{1.5} |
| Example 2-3 | | | | | | |
| Comparative Synthesis | — | 2 | — | 1 | — | Li₂ZrCl₄F₂ |
| Example 2-4 | | | | | | |
| Synthesis Example 2-1 | — | 1 | 0.50 | 1.25 | — | 1/4ZrO₂—Li₂ZrCl₅F |
| Synthesis Example 2-2 | — | 1 | 1 | 1.50 | | LiCl—1/4ZrO₂—Li₂ZrCl₅F |
| Synthesis Example 2-3 | — | — | 2 | 2.50 | 0.50 | ZrO₂—2Li₂ZrCl₅F |
| Synthesis Example 2-4 | — | 0.50 | 2.06 | 2.50 | 0.50 | 0.5LiF—1.03ZrO₂—1.97Li₂ZrCl₅F |
| Synthesis Example 2-5 | — | 1.00 | 2.12 | 2.50 | 0.50 | 1.00LiF—1.06ZrO₂—1.94Li₂ZrCl₅F |

The lithium halide-based composites or the lithium halide-based nanocomposites were measured with respect to ionic conductivity in the following method. In a glove box under an argon atmosphere, samples were weighed and placed in a polyetheretherketone tube (a PEEK tube with an interior diameter of 13 mm, an exterior diameter of 32 mm, and a height of 10 mm) and then, the PEEK tube was inserted so that upper and lower portions of the PEEK tube contact a powder-molding jig containing Ti. Subsequently, the samples were pressed into pellets with a diameter of 13 mm and any thickness by using a single screw press at a molding pressure of about 370 MPa. The obtained pellets were placed in the sealed electrochemical cell capable of maintaining the argon atmosphere.

The ionic conductivity was measured by using an impedance/gain phase analyzer (SP-300, BioLogic) as a frequency response analyzer (FRA) and a small environmental tester as a constant temperature device. The measurement was started from a high frequency region at an AC voltage of 10 mV to 100 mV within a frequency range of 10 Hz to 7 MHz at a temperature of 30° C.

Herein, the results of Synthesis Examples 2-1 to 2-3 are shown in Table 4. For comparison, the results of Comparative Synthesis Examples 1 and 2-1 to 2-4 are also described.

TABLE 4

| | Lithium halide-based | Ionic |
|---|---|---|
| | composite or lithium | conductivity |
| | halide-based nanocomposite | (mS cm⁻¹) |
| Comparative Synthesis | Li₂ZrCl₆ | 0.40 |
| Example 1 | | |
| Comparative Synthesis | Li₂ZrCl₅F | 0.35 |
| Example 2-1 | | |
| Comparative Synthesis | Li₂ZrCl₅F | 0.37 |
| Example 2-2 | | |
| Comparative Synthesis | Li₂ZrCl_{4.5}F_{1.5} | 0.29 |
| Example 2-3 | | |
| Comparative Synthesis | Li₂ZrCl₄F₂ | 0.24 |
| Example 2-4 | | |
| Synthesis Example 2-1 | ¼ZrO₂—Li₂ZrCl₅F | 0.68 |
| Synthesis Example 2-2 | LiCl—¼ZrO₂—Li₂ZrCl₅F | 0.63 |
| Synthesis Example 2-3 | ZrO₂—2Li₂ZrCl₅F | 0.61 |

Referring to Table 4, the lithium halide-based nanocomposites according to Synthesis Examples 2-1 to 2-3 exhibited improved ionic conductivity, compared with the lithium halide-based composites according to Comparative Synthesis Examples 1 and 2-1 to 2-4.

### Synthesis Examples 3-1 to 3-7: Preparation of Lithium Halide-Based Nanocomposite

represented by any one of Chemical Formulas 3A to 3C and measurement of ionic conductivity A lithium-containing oxidizing agent (A), first metal halide (B), and lithium halide (C1) were put in a mole ratio (A:B:C1) shown in Table 5 and then, mechanically milled by using Pulverisette 7 PL (Fritsch GmbH) under an Ar atmosphere in a 50 ml ZrO₂ vial with 15 ZrO₂ balls (Φ=10 mm) at 600 rpm for 20 hours, preparing lithium halide-based nanocomposite (D) represented by one of Chemical Formulas 1A to 1C (first step).

The halide-based nanocomposite powder (D) represented by one of Chemical Formulas 1A to 1C, third metal halide (E1), and lithium halide (C2) were put in a mole ratio shown in Table 5 and then, mechanically milled by using Pulverisette 7 PL (Fritsch GmbH) under an Ar atmosphere in a 50 ml ZrO₂ vial with 15 ZrO₂ balls (Φ=10 mm) at 600 rpm for 20 hours, preparing lithium a halide-based nanocomposite represented by one of Chemical Formulae 3A to 3C (second step).

TABLE 5

| | First step | | | | | | | | | |
|---|---|---|---|---|---|---|---|---|---|---|
| | Lithium- | | | | | Second step | | | | |
| | containing | First | First | | | Lithium | | Third | | |
| | oxidizing | metal | metal | Lithium | | halide-based | Lithium | metal | | Lithium |
| | agent | halide | halide | halide | | nanocomposite | halide | halide | | halide-based |
| | (A) | (B1) | (B2) | (C1) | Mole ratio | (D) | (C2) | (E1) | Mole ratio | nanocomposite |
| Synthesis | Li₂O | ZrCl₄ | — | — | A:B1:C1 = 2:3:0 | ZrO₂— | LiCl | FeCl₃ | D:C2:E | 0.9ZrO₂— |
| Example 3-1 | | | | | | 2Li₂ZrCl₆ | | | 1 = 1:8/9:2/9 | 2Li_{2.1}Zr_{0.9}Fe_{0.1}Cl₆ |
| Synthesis | Li₂O | ZrCl₄ | — | — | A:B1:C1 = 2:3:0 | ZrO₂— | LiCl | FeCl₃ | D:C2:E | 0.75ZrO₂— |
| Example 3-2 | | | | | | 2Li₂ZrCl₆ | | | 1 = 1:2:2/3 | 2Li_{2.25}Zr_{0.75}Fe_{0.25}Cl₆ |
| Synthesis | Li₂O | ZrCl₄ | — | — | A:B1:C1 = 2:3:0 | ZrO₂— | LiCl | FeCl₃ | D:C2:E | 0.6ZrO₂— |
| Example 3-3 | | | | | | 2Li₂ZrCl₆ | | | 1 = 1:13/3:4/3 | 2Li_{2.4}Zr_{0.6}Fe_{0.4}Cl₆ |
| Synthesis | Li₂O | ZrCl₄ | — | — | A:B1:C1 = 1:1:0 | 2LiCl— | LiCl | FeCl₃ | D:C2:E | 1.8LiCl— |
| Example 3-4 | | | | | | ZrO₂—Li₂ZrCl₆ | | | 1 = 0.9:0.3:0.3 | 0.9ZrO₂— |
| | | | | | | | | | | Li_{2.1}Zr_{0.9}Fe_{0.1}Cl₆ |
| Synthesis | Li₂O | ZrCl₄ | — | — | A:B1:C1 = 1:1:0 | 2LiCl— | LiCl | FeCl₃ | D:C2:E | 1.5LiCl— |
| Example 3-5 | | | | | | ZrO₂—Li₂ZrCl₆ | | | 1 = 0.75:0.25:1 | 0.75ZrO₂— |
| | | | | | | | | | | Li_{2.25}Zr_{0.75}Fe_{0.25}Cl₆ |
| Synthesis | Li₂O | ZrCl₄ | ZrF₄ | — | A:B1:B2: | ZrO₂— | LiCl | YbCl₃ | D:C2:E | 0.9ZrO₂— |
| Example 3-6 | | | | | C1 = 2:2.5:0.5:0 | 2Li₂ZrCl₅F | | | 1 = 1:8/9:2/9 | 2Li_{2.1}Zr_{0.9}Yb_{0.1}Cl₆ |
| Synthesis | Li₂O | ZrCl₄ | ZrF₄ | — | A:B1:B2: | ZrO₂— | LiCl | YbCl₃ | D:C2:E | 0.6ZrO₂— |
| Example 3-7 | | | | | C1 = 2:2.5:0.5:0 | 2Li₂ZrCl₅F | | | 1 = 1:13/3:4/3 | 2Li_{2.4}Zr_{0.6}Yb_{0.4}Cl₆ |

The lithium halide-based nanocomposites according to Synthesis Examples 3-1 to 3-7 were measured with respect to ionic conductivity in the following method. In a glove box under an argon atmosphere, each sample was weighed and placed in a polyetheretherketone tube (a PEEK tube with an interior diameter of 13 mm, an exterior diameter of 32 mm, and a height of 10 mm), and the PEEK tube was inserted so that upper and lower portions of the PEEK tube contact a powder-molding jig containing Ti. Subsequently, the samples were pressed into pellets with a diameter of 13 mm and any thickness by using a single screw press at a molding pressure of about 370 MPa. Then, the obtained pellets were placed in a sealed electrochemical cell capable of maintaining the argon atmosphere.

The ionic conductivity was measured by using an impedance/gain phase analyzer (SP-300, BioLogic) as a frequency response analyzer (FRA) and a small environmental tester as a constant temperature device. The measurement was started from a high frequency region at an AC voltage of 10 mV to 100 mV within a frequency range of 10 Hz to 7 MHz at a temperature of 30° C.

The measurement results are shown in Table 6.

TABLE 6

| | | Ionic |
|---|---|---|
| | Lithium halide-based | conductivity |
| | nanocomposite | (mS cm⁻¹) |
| Synthesis | 0.9ZrO₂—2Li_{2.1}Zr_{0.9}Fe_{0.1}Cl₆ | 1.31 |
| Example 3-1 | | |
| Synthesis | 0.75ZrO₂—2Li_{2.25}Zr_{0.75}Fe_{0.25}Cl₆ | 1.40 |
| Example 3-2 | | |
| Synthesis | 0.6ZrO₂—2Li_{2.4}Zr_{0.6}Fe_{0.4}Cl₆ | 1.06 |
| Example 3-3 | | |
| Synthesis | 1.8LiCl—0.9ZrO₂—Li_{2.1}Zr_{0.9}Fe_{0.1}Cl₆ | 1.34 |
| Example 3-4 | | |
| Synthesis | 1.5LiCl—0.75ZrO₂—Li_{2.25}Zr_{0.75}Fe_{0.25}Cl₆ | 0.87 |
| Example 3-5 | | |
| Synthesis | 0.9ZrO₂—2Li_{2.1}Zr_{0.9} Yb_{0.1}Cl₆ | 0.73 |
| Example 3-6 | | |
| Synthesis | 0.6ZrO₂—2Li_{2.4}Zr_{0.6}Yb_{0.4}Cl₆ | 0.61 |
| Example 3-7 | | |

Referring to Table 6, the lithium halide-based nanocomposites according to Synthesis Examples 3-1 to 3-7 exhibited improved ionic conductivity.

### Evaluation Example 1: XRD Analysis

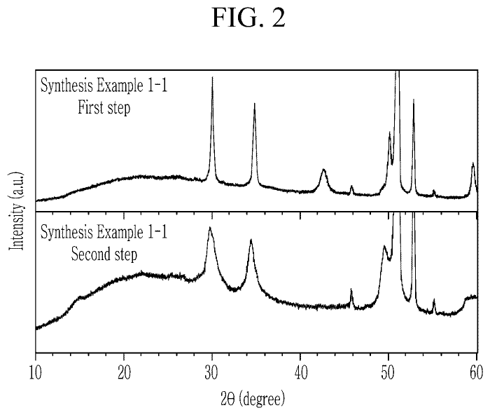

FIGS. 2 to 5 show X-ray diffraction (XRD) results of the lithium halide-based nanocomposites according to the synthesis examples and the lithium halide-based composites according to the comparative synthesis examples. In a glove box under an argon atmosphere, the samples were sealed by using a Be cover. The X-ray diffraction (XRD) results were obtained by using an X-ray diffraction analyzer (Miniflex-600, Rigaku Corp.) and Cu Kα as an X-ray source within a measurement range of 10° to 80° at a step-size of 0.02° and a rate of 2.0 deg/min.

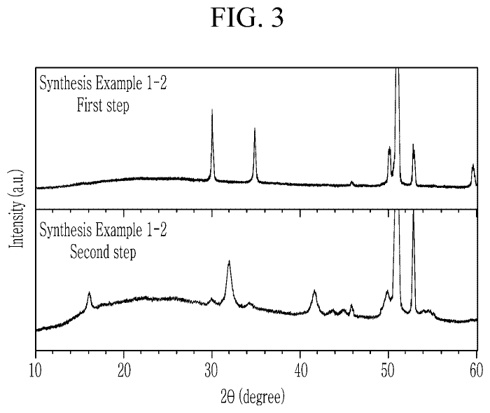

FIGS. 2 and 3 are graphs showing X-ray diffraction (XRD) analysis results of the products prepared in each step (first and second steps) of Synthesis Examples 1-1 and 1-2. Referring to FIG. 2, a peak of LiCl appeared around 29° and 34° due to (2LiCl+MgO) prepared in the first step, and another peak of MgO appeared around 40°, and still another peak of Li₂MgCl₄ with a cubic structure appeared around 29° and 34° in the second step. Referring to FIG. 3, the LiCl peak appeared around 29° and 34° due to (6LiCl+Al₂O₃) prepared in the first step, and since Al₂O₃ was amorphous, there was no peak, and in the second step, a peak of Li₂ZrCl₆ with a trigonal structure appeared around 15°, 31°, and 41°.

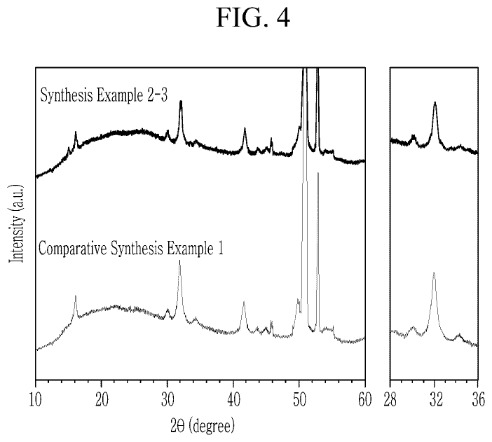

FIG. 4 is a graph showing X-ray diffraction analysis results of the lithium halide-based composites according to Comparative Synthesis Example 1 and the lithium halide-based nanocomposite according to Synthesis Example 2-3. Referring to FIG. 4, the lithium halide-based composite according to Comparative Synthesis Example 1 exhibited a peak of Li₂ZrCl₆ with a trigonal structure around 15°, 31°, and 41°, and the lithium halide-based nanocomposite of Synthesis Example 2-3 exhibited that the peak of Li₂ZrCl₆ with a trigonal structure around 15°, 31°, and 41° was shifted toward right due to F substitution. ZrO₂ of the lithium halide nanocomposite of Synthesis Example 2-3 was amorphous or formed into several nanometer-sized crystals and thus exhibited no peak.

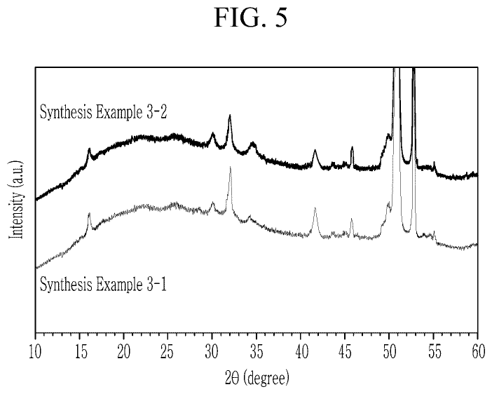

FIG. 5 is a graph showing X-ray diffraction analysis results of the lithium halide-based nanocomposites according to Synthesis Examples 3-1 and 3-2. Referring to FIG. 5, the lithium halide-based nanocomposites according to Synthesis Examples 3-1 and 3-2 exhibited the peak of Li₂ZrCl₆ with a trigonal structure around 15°, 31°, and 41°. ZrO₂ of the lithium halide nanocomposite of Synthesis Example 3-1 or 3-2 was amorphous or formed into several nanometer-sized crystals and thus exhibited no peak.

### Evaluation Example 2: Impedance Analysis

The impedance was measured in the following method. In a glove box under an argon atmosphere, samples were weighed and placed in a polyetheretherketone tube (a PEEK tube with an interior diameter of 13 mm, an exterior diameter of 32 mm, and a height of 10 mm), and the PEEK tube was inserted so that upper and lower portions of the PEEK tube contact a powder-molding jig containing Ti. Subsequently, the samples were pressed into pellets with a diameter of 13 mm and any thickness by using a single screw press at a molding pressure of about 370 MPa. Then, the obtained pellets were placed in a sealed electrochemical cell capable of maintaining the argon atmosphere.

The impedance was measured by using an impedance/gain phase analyzer (SP-300, BioLogic) as a frequency response analyzer (FRA) and a small environmental tester as a constant temperature device. The measurement was started from a high frequency region at an AC voltage of 10 mV to 100 mV within a frequency range of 10 Hz to 7 MHz at a temperature of 30° C.

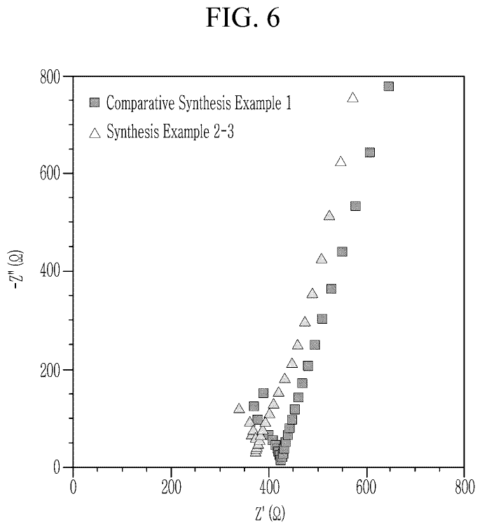

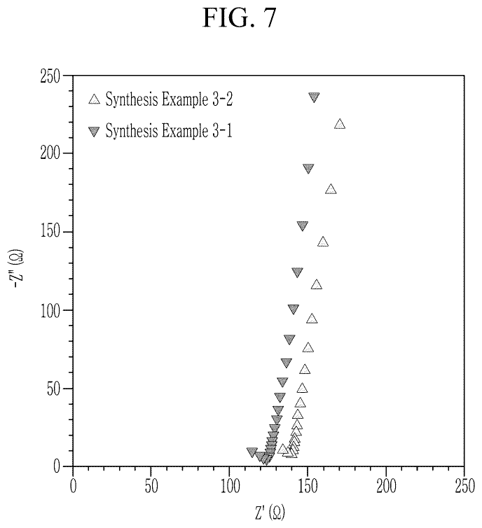

The lithium halide-based composites of Comparative Synthesis Example 1 and the lithium halide-based nanocomposites of Synthesis Examples 2-3, 3-1, and 3-2 were measured with respect to impedance, and the results are shown in FIGS. 6 and 7. FIG. 6 is a graph showing the impedance results of the lithium halide-based composites according to Comparative Synthesis Example 1 and the lithium halide-based nanocomposites according to Synthesis Example 2-3, and FIG. 7 is a graph showing the impedance results of the lithium halide-based nanocomposites according to Synthesis Examples 3-1 and 3-2. Referring to FIGS. 6 and 7, the lithium halide-based nanocomposite of Synthesis Example 2-3 and the lithium halide-based nanocomposites of Synthesis Example 3-1 and Synthesis Example 3-2 exhibited significantly reduced impedance compared with the lithium halide-based composites according to Comparative Synthesis Example 1. Accordingly, the lithium halide-based nanocomposites of Synthesis Examples 2-3, 3-1, and 3-2 exhibited excellent electrical conductivity.

### Evaluation Example 3: Electrochemical Characteristic Evaluation by Cyclic Voltammetry Method

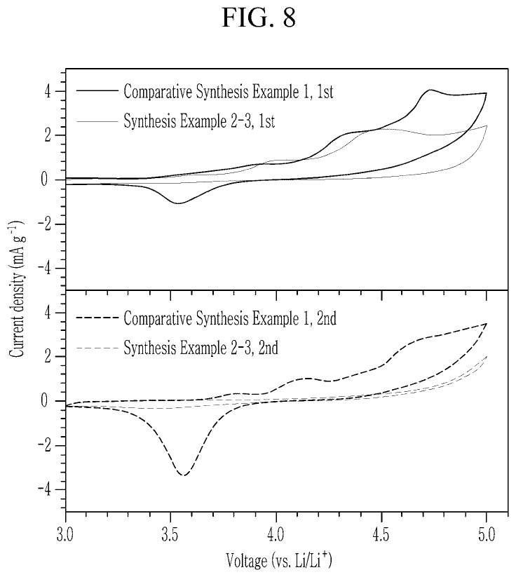

The Composites were Evaluated with Respect to Electrochemical Stability Through cyclic voltammetry performed within a voltage range of 3 V to 5 V. FIG. 8 shows the cyclic voltammetry results of the lithium halide-based nanocomposite (ZrO₂-2Li₂ZrCl₅F) of Synthesis Example 2-3 and the lithium halide-based composite (Li₂ZrCl₆) of Comparative Synthesis Example 1. Referring to FIG. 8, the lithium halide-based nanocomposite (ZrO₂-2Li₂ZrCl₅F) of Synthesis Example 2-3 exhibited a low current at the first cycle, compared with the lithium halide-based composite (Li₂ZrCl₆) of Comparative Synthesis Example 1, which confirms that the lithium halide-based nanocomposite of Synthesis Example 2-3 exhibited excellent electrochemical stability compared with the lithium halide-based composite of Comparative Synthesis Example 1. In addition, the lithium halide-based nanocomposite of Synthesis Example 2-3 exhibited a sharply decreased current at the second cycle, but the lithium halide-based composite of Comparative Synthesis Example 1 maintained a high current, which confirms that even at the second cycle, the lithium halide-based nanocomposite of Synthesis Example 2-3 exhibited excellent electrochemical stability, compared with the lithium halide-based composite of Comparative Synthesis Example 1.

### Examples: Manufacture of all-Solid-State Battery Cell I

The lithium halide-based nanocomposites of Synthesis Examples 1-1 to 3-7 and the lithium halide-based composites of Comparative Synthesis Examples 1 to 2-4 were respectively used as a solid electrolyte to manufacture all-solid-state battery cells in the following method. LiCoO₂ as a positive electrode active material, a solid electrolyte, and Super-C as a conductive material were used in a weight ratio of 70:30:3 to prepare slurry and coating the slurry on an Al foil and drying and pressing it to prepare a positive electrode active material layer. The positive electrode active material layer (40 μm), a solid electrolyte layer (150 μm) including the lithium halide-based composites or the lithium halide-based nanocomposite, and Li—In as a negative electrode (130 μm) were stacked and pressed to manufacture all-solid-state battery cells. Hereinafter, the all-solid-state battery cells manufactured in “Manufacture of all-solid-state battery cell I” are marked as Examples 1-1A to 3-7A and Comparative Examples 1A to 2-4A.

### Examples: Manufacture of all-Solid-State Battery Cell II

All-solid-state battery cells were manufactured in the same manner as in “Manufacture of all-solid-state battery cell I” except that LiNi_{0.88}Co_{0.11}Al_{0.01}O₂ was used instead of the LiCoO₂ as the positive electrode active material. Hereinafter, the all-solid-state battery cells manufactured in “Manufacture of all-solid-state battery cell II” were marked as Examples 1-1B to 3-7B and Comparative Examples 1B to 2-4B.

### Evaluation Example 4: Charge and Discharge Characteristics and Cycle-Life Characteristics of Battery Cells

The manufactured all-solid-state battery cells were charged with a constant current up to 4.3 V, paused at 4.3 V until the current reached 0.1 C, and cut off and then, discharged with the constant current to 3.0 V in environments of 30° C. and 60° C. to evaluate charge and discharge characteristics. Subsequently, the all-solid-state battery cells were charged with a constant current to 4.3 V, paused at 4.3 V until the current reached 0.5 C, and cut off and then, discharged to 3.0 V with the constant current in the environments of 30° C. and 60° C., wherein this charge and discharge was 100 times repeated.

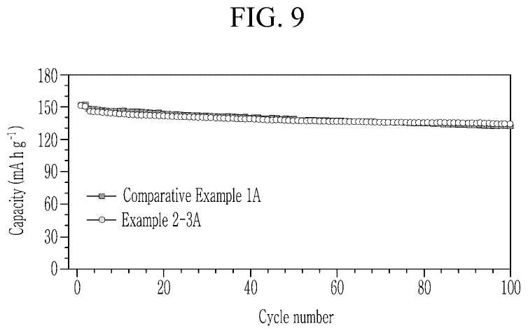

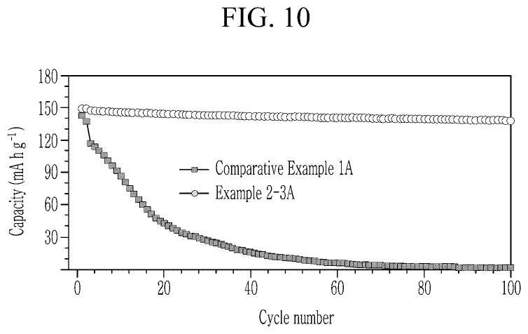

Herein, the charge and discharge characteristics at 30° C. and 60° C. of the all-solid-state battery cell of Example 2-3A are shown in Table 7, and the cycle-life characteristics at 30° C. are shown in FIG. 9, while the cycle-life characteristics at 60° C. are shown in FIG. 10. FIG. 9 is a graph showing the cycle-life characteristics at 30° C. of the all-solid-state battery cell according to Example 2-3A, and FIG. 10 is a graph showing the cycle-life characteristics at 60° C. of the all-solid-state battery cell according to Example 2-3A. In FIGS. 9 and 10, cycle-life characteristics of the all-solid-state battery cell according to Comparative Example 1A were shown for comparison.

The all-solid-state battery cell of Example 2-3B was charged with a constant current up to 4.3 V, paused at 4.3 V until the current reached 0.5 C, and cut off and then, discharged with the constant current to 3.0 V in the environments of 30° C. and 60° C. to evaluate charge and discharge characteristics. Subsequently, the all-solid-state battery cell was charged with a constant current up to 4.3 V, paused at 4.3 V until the current reached 2 C, and cut off and then, discharged with a constant current to 3.0 V in the environments of 30° C. and 60° C., wherein this charge and discharge were 2000 times repeated.

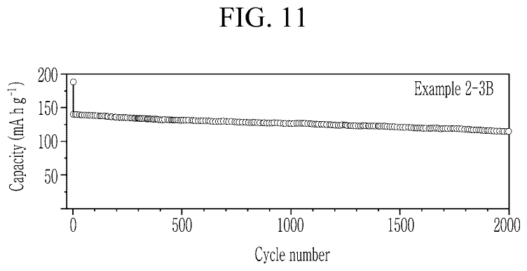

The charge and discharge characteristics at 30° C. of the all-solid-state battery cell of Example 2-3B are shown in Table 7, and the cycle-life characteristics at 60° C. are shown in FIG. 11. FIG. 11 is a graph showing the cycle-life characteristics at 60° C. of the all-solid-state battery cell according to Example 2-3B.

TABLE 7

| | Lithium halide-based | | | | | |
|---|---|---|---|---|---|---|
| | composite or Lithium | | | | | |
| | halide-based | Charge | | | | Cycle-life |
| | nanocomposite used in | and | | | | characteristics |
| | positive electrode layer | discharge | Charge | Discharge | | (Capacity |
| | and solid electrolyte | temperature | capacity | capacity | ICE | retention) |
| Nos. | layer | (° C.) | (mAh g⁻¹) | (mAh g⁻¹) | (%) | (%) |
| Comp. | Comparative Synthesis | 30 | 164 | 153 | 93.3 | 88.7 |
| Ex. 1A | Example 1 (Li₂ZrCl₆) | | | | | |
| Ex. 2-3A | Synthesis Example 2-3 | 30 | 157 | 151 | 96.2 | 92.1 |
| | (ZrO₂—2Li₂ZrCl₅F) | | | | | |
| Comp. | Comparative Synthesis | 60 | 187 | 150 | 80.2 | 1.7 |
| Ex. 1A | Example 1 (Li₂ZrCl₆) | | | | | |
| Ex. 2-3A | Synthesis Example 2-3 | 60 | 165 | 157 | 95.2 | 93.7 |
| | (ZrO₂—2Li₂ZrCl₅F) | | | | | |
| Ex. 2-3B | Synthesis Example 2-3 | 30 | 225 | 188 | 83.4 | 90.8 |
| | (ZrO₂—2Li₂ZrCl₅F) | | | | | (3^{rd}/1000^{th}) |

Referring to Table 7 and FIGS. 9 to 11, the all-solid-state battery cells according to the examples turned out to be excellent at 30° C. and 60° C., compared with the all-solid-state battery cells according to the comparative examples, and particularly, exhibited significantly improved charge and discharge characteristics and cycle-life characteristics at a high temperature.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. A lithium halide-based nanocomposite represented by any one of Chemical Formulas 1A to 1C, in which a nanosized compound selected from M¹O_{c}, LiX, and a combination thereof is dispersed in a halide compound of LiₐM²X_{b}:
M¹O_{c}—LiₐM^{z}X_{b} [Chemical Formula 1A]
wherein, in Chemical Formula 1A, M¹ and M² are different from each other and are each independently one or more selected from Mg, Ca, Zn, Cd, Cu, Sc, Y, B, Al, Ga, In, Ln, Ti, Zr, Hf, Nb, Ta, Mo, W, Sb, Si, Ge, Sn, V, Cr, Mn, Fe, Co, and Ni, Ln is La, Ce, Pr, Nd, Pm, Sm, Eu, Gd, Tb, Dy, Ho, Er, Yb, or Lu, X is Cl, Br, F, or I, and a, b, and c are each independently in the range of 0.01 to 10,
LiX—LiₐM²X_{b} [Chemical Formula 1B]
wherein, in Chemical Formula 1B, M² is one or more selected from Mg, Ca, Zn, Cd, Cu, Sc, Y, B, Al, Ga, In, Ln, Ti, Zr, Hf, Nb, Ta, Mo, W, Sb, Si, Ge, Sn, V, Cr, Mn, Fe, Co, and Ni, Ln is La, Ce, Pr, Nd, Pm, Sm, Eu, Gd, Tb, Dy, Ho, Er, Yb, or Lu, X is Cl, Br, F, or I, and a and b are each independently in the range of 0.01 to 10,
M¹O_{c}—LiX—LiₐM²X_{b} [Chemical Formula 1C]
wherein, in Chemical Formula 1C, M¹ and M² are different from each other and are each independently one or more selected from Mg, Ca, Zn, Cd, Cu, Sc, Y, B, Al, Ga, In, Ln, Ti, Zr, Hf, Nb, Ta, Mo, W, Sb, Si, Ge, Sn, V, Cr, Mn, Fe, Co, and Ni, Ln is La, Ce, Pr, Nd, Pm, Sm, Eu, Gd, Tb, Dy, Ho, Er, Yb, or Lu, X is Cl, Br, F, or I, and a, b, and c are each independently in the range of 0.01 to 10.

2. The lithium halide-based nanocomposite of claim 1, wherein
in LiₐM²X_{b} of Chemical Formulas 1A to 1C, X_{b} is X¹_{b-d}X²_{d} wherein X¹ and X² are different from each other and are each independently Cl, Br, F, or I, b is in the range of 0.01 to 10, and d is in the range of 0.01 to 4.

3. The lithium halide-based nanocomposite of claim 1, wherein
in LiₐM²X_{b} of Chemical Formulas 1A to 1C, X_{b} is Cl_{b-d}F_{d} or Cl_{b-d}I_{d}, wherein b is in the range of 0.01 to 10 and d is the range of 0.01 to 4.

4. The lithium halide-based nanocomposite of claim 1, wherein
the lithium halide-based nanocomposite represented by Chemical Formula 1A includes about 1 to about 20 vol % of M¹O_{c} and about 80 to about 99 vol % of LiₐM²X_{b}; the lithium halide-based nanocomposite represented by Chemical Formula 1B includes about 6 to about 34 vol % of LiX and about 66 to about 94 vol % of LiₐM²X_{b}; and the lithium halide-based nanocomposite represented by Chemical Formula 1C includes about 1 to about 13 vol % of M¹O_{c}, about 1 to about 29 vol % of LiX, and about 65 to about 94 vol % of LiₐM²X_{b}.

5. The lithium halide-based nanocomposite of claim 1, wherein
the nanosized compound selected from the M¹O_{c}, LiX, or the combination thereof is an in-situ grown compound and has a crystal size of less than or equal to about 100 nm.

6. The lithium halide-based nanocomposite of claim 1, wherein
the nanosized compound selected from M¹O_{c}, LiX, or the combination thereof is formed in a network shape inside the halide compound (LiₐM²X_{b}).

7. The lithium halide-based nanocomposite of claim 1, wherein
the lithium halide-based nanocomposite has an ionic conductivity of about 0.1 to about 5 mS/cm.

8. The lithium halide-based nanocomposite of claim 1, wherein
the lithium halide-based nanocomposite has a glass-ceramic crystal structure.

9. The lithium halide-based nanocomposite of claim 1, wherein
the lithium halide-based nanocomposite exhibits a first effective peak and a second effective peak in the ranges of about 0.4 to about 0.6 ppm and about −0.2 to about 0.2 ppm, respectively, in a ⁶Li MAS NMR analysis result, and
an intensity ratio of the first effective peak to the second effective peak is about 0.7 to about 0.8.

10. A lithium halide-based nanocomposite represented by any one of Chemical Formulas 2A to 2C, in which a nanosized compound selected from M¹O_{c}, LiX, and a combination thereof is dispersed in a halide compound of LiₐM²X¹_{b-d}X²_{d}:
M¹O_{c}—LiₐM²X¹_{b-d}X²_{d} [Chemical Formula 2A]
wherein, in Chemical Formula 2A, M¹ and M² are the same or different, and are each independently one or more selected from Mg, Ca, Zn, Cd, Cu, Sc, Y, B, Al, Ga, In, Ln, Ti, Zr, Hf, Nb, Ta, Mo, W, Sb, Si, Ge, Sn, V, Cr, Mn, Fe, Co, and Ni, Ln is La, Ce, Pr, Nd, Pm, Sm, Eu, Gd, Tb, Dy, Ho, Er, Yb, or Lu, X¹ and X² are different from each other and are each independently Cl, Br, F, or I, a, b, and c are each independently in the range of 0.01 to 10, and d is in the range of 0.01 to 4,
LiX—LiₐM²X¹_{b-d}X²_{d} [Chemical Formula 2B]
wherein, in Chemical Formula 2B, M² is one or more selected from Mg, Ca, Zn, Cd, Cu, Sc, Y, B, Al, Ga, In, Ln, Ti, Zr, Hf, Nb, Ta, Mo, W, Sb, Si, Ge, Sn, V, Cr, Mn, Fe, Co, and Ni, Ln is La, Ce, Pr, Nd, Pm, Sm, Eu, Gd, Tb, Dy, Ho, Er, Yb, or Lu, X is Cl, Br, F, or I, X¹ and X² are different from each other and are each independently Cl, Br, F, or I, a and b are each independently in the range of 0.01 to 10, and d is in the range of 0.01 to 4,
M¹O_{c}—LiX—LiₐM²X¹_{b-d}X^{z}_{d} [Chemical Formula 2C]
wherein, in Chemical Formula 2C, M¹ and M² are each independently one or more selected from Mg, Ca, Zn, Cd, Cu, Sc, Y, B, Al, Ga, In, Ln, Ti, Zr, Hf, Nb, Ta, Mo, W, Sb, Si, Ge, Sn, V, Cr, Mn, Fe, Co, and Ni, Ln is La, Ce, Pr, Nd, Pm, Sm, Eu, Gd, Tb, Dy, Ho, Er, Yb, or Lu, X is Cl, Br, F, or I, X¹ and X² are different from each other and are each independently Cl, Br, F, or I, a, b, and c are each independently in the range of 0.01 to 10, and d is in the range of 0.01 to 4.

11. The lithium halide-based nanocomposite of claim 10, wherein
LiₐM²X¹_{b-d}X²_{d} in Chemical Formulas 2A to 2C is LiₐM²Cl_{b-d}F_{d} or Li^{a}M²Cl_{b-d}I_{d} wherein a and b is in the range of 0.01 to 10 and d is the range of 0.01 to 4.

12. The lithium halide-based nanocomposite of claim 10, wherein
in LiₐM²X¹_{b-d}X²_{d} of Chemical Formulas 2A to 2C, a portion of M² is substituted with M³ to be a compound represented by LiₐM²₁₋ₑM³ₑX¹_{b-d}X²_{d}, wherein M², X¹, X², a, b, and d are the same as in Chemical Formulas 2A to 2C, and M³ is the same as or different from M¹ and is one or more selected from Mg, Ca, Zn, Cd, Cu, Sc, Y, B, Al, Ga, In, Ln, Ti, Zr, Hf, Nb, Ta, Mo, W, Sb, Si, Ge, Sn, V, Cr, Mn, Fe, Co, and Ni, Ln is La, Ce, Pr, Nd, Pm, Sm, Eu, Gd, Tb, Dy, Ho, Er, Yb, or Lu, and e is in the range of 0.01 to 0.9.

13. The lithium halide-based nanocomposite of claim 10, wherein
the lithium halide-based nanocomposite represented by Chemical Formula 2A includes about 1 to about 20 vol % of M¹O_{c} and about 80 to about 99 vol % of LiₐM²X¹_{b-d}X²_{d}; the lithium halide-based nanocomposite represented by Chemical Formula 2B includes about 6 to about 34 vol % of LiX and about 66 to about 94 vol % of LiₐM²X¹_{b-d}X²_{d}; and the lithium halide-based nanocomposite represented by Chemical Formula 2C includes about 1 to about 13 vol % of M¹O_{c}, about 1 to about 29 vol % of LiX, and about 65 to about 94 vol % of LiₐM²X¹_{b-d}X²_{d}.

14. The lithium halide-based nanocomposite of claim 10, wherein
the nanosized compound selected from M¹O_{c}, LiX, and the combination thereof is an in-situ grown compound and has a crystal size of less than or equal to about 100 nm.

15. The lithium halide-based nanocomposite of claim 10, wherein
the nanosized compound selected from M¹O_{c}, LiX, or the combination thereof is formed in a network shape inside a halide compound (LiₐM²X¹_{b-d}X²_{d}).

16. The lithium halide-based nanocomposite of claim 10, wherein
the lithium halide-based nanocomposite has an ionic conductivity of about 0.1 to about 5 mS/cm at 30° C.

17. The lithium halide-based nanocomposite of claim 10, wherein
the lithium halide-based nanocomposite has a glass-ceramic crystal structure.

18. The lithium halide-based nanocomposite of claim 10, wherein
the lithium halide-based nanocomposite exhibits a first effective peak and a second effective peak in the ranges of about 0.4 to about 0.6 ppm and about −0.2 to about 0.2 ppm, respectively, in a ⁶Li MAS NMR analysis result, and
an intensity ratio of the first effective peak to the second effective peak is about 0.7 to about 0.8.

19. A lithium halide-based nanocomposite represented by any one of Chemical Formulas 3A to 3C, in which a nanosized compound selected from M¹O_{c}, LiX, and a combination thereof is dispersed in a halide compound of LiₐM²₁₋ₑM³ₑX_{b}:
M¹O_{c}—LiₐM²₁₋ₑM³ₑX_{b} [Chemical Formula 3A]
wherein, in Chemical Formula 3A, M¹, M², and M³ are each independently one or more selected from Mg, Ca, Zn, Cd, Cu, Sc, Y, B, Al, Ga, In, Ln, Ti, Zr, Hf, Nb, Ta, Mo, W, Sb, Si, Ge, Sn, V, Cr, Mn, Fe, Co, and Ni, Ln is La, Ce, Pr, Nd, Pm, Sm, Eu, Gd, Tb, Dy, Ho, Er, Yb, or Lu, X is Cl, Br, F, or I, M² and M³ are different from each other, a, b, and c are each independently in the range of 0.01 to 10, and e is in the range of 0.01 to 0.9,
LiX—LiₐM²₁₋ₑM³ₑX_{b} [Chemical Formula 3B]
wherein, in Chemical Formula 3B, M² and M³ are different from each other and are each independently one or more selected from Mg, Ca, Zn, Cd, Cu, Sc, Y, B, Al, Ga, In, Ln, Ti, Zr, Hf, Nb, Ta, Mo, W, Sb, Si, Ge, Sn, V, Cr, Mn, Fe, Co, and Ni, Ln is La, Ce, Pr, Nd, Pm, Sm, Eu, Gd, Tb, Dy, Ho, Er, Yb, or Lu, X is Cl, Br, F, or I, a and b are each independently in the range of 0.01 to 10, and e is in the range of 0.01 to 0.9,
M¹O_{c}—LiX—LiₐM²₁₋ₑM³ₑX_{b} [Chemical Formula 3C]
wherein, in Chemical Formula 3C, M¹, M², and M³ are each independently one or more selected from Mg, Ca, Zn, Cd, Cu, Sc, Y, B, Al, Ga, In, Ln, Ti, Zr, Hf, Nb, Ta, Mo, W, Sb, Si, Ge, Sn, V, Cr, Mn, Fe, Co, and Ni, Ln is La, Ce, Pr, Nd, Pm, Sm, Eu, Gd, Tb, Dy, Ho, Er, Yb, or Lu, X is Cl, Br, F, or I, a, b, and c are each independently in the range of 0.01 to 10, and e is in the range of 0.01 to 0.9.

20. The lithium halide-based nanocomposite of claim 19, wherein
in LiₐM²₁₋ₑM³ₑX_{b} of Chemical Formula 3A to 3C, X_{b} is X¹_{b-d}X²_{d} wherein X¹ and X² are different from each other and are each independently Cl, Br, F, or I, b is in the range of 0.01 to 10, and d is in the range of 0.01 to 4.

21. The lithium halide-based nanocomposite of claim 19, wherein
the lithium halide-based nanocomposite represented by Chemical Formula 3A includes about 1 to about 20 vol % of M¹O_{c} and about 80 to about 99 vol % of LiₐM²₁₋ₑM³ₑX_{b}; the lithium halide-based nanocomposite represented by Chemical Formula 3B includes about 6 to about 34 vol % of LiX, about 66 to about 94 vol % of LiₐM²₁₋ₑM³ₑX_{b}; and the lithium halide-based nanocomposite represented by Chemical Formula 3C includes about 1 to about 13 vol % of M¹O_{c}, about 1 to about 29 vol % of LiX, and about 65 to about 94 vol % of LiₐM²₁₋ₑM³ₑX_{b}.

22. The lithium halide-based nanocomposite of claim 19, wherein
the nanosized compound selected from M¹O_{c}, LiX, or the combination thereof is an in-situ grown compound and has a crystal size of less than or equal to about 100 nm.

23. The lithium halide-based nanocomposite of claim 19, wherein
the nanosized compound selected from M¹O_{c}, LiX, or the combination thereof is formed in a network shape inside a halide compound (LiₐM²₁₋ₑM³ₑX_{b}).

24. The lithium halide-based nanocomposite of claim 19, wherein
the lithium halide-based nanocomposite has an ionic conductivity of about 0.1 to about 5 mS/cm at 30° C.

25. The lithium halide-based nanocomposite of claim 19, wherein
the lithium halide-based nanocomposite has a glass-ceramic crystal structure.

26. The lithium halide-based nanocomposite of claim 19, wherein
the lithium halide-based nanocomposite exhibits a first effective peak and a second effective peak in the ranges of about 0.4 to about 0.6 ppm and about −0.2 to about 0.2 ppm, respectively, in a ⁶Li MAS NMR analysis result, and
an intensity ratio of the first effective peak to the second effective peak is about 0.7 to about 0.8.

27. A method of preparing a lithium halide-based nanocomposite represented by any one of Chemical Formulas 1A to 1C, comprising
performing a solid-phase reaction of a lithium-containing oxidizing agent and a first metal (M¹)-containing halide under an inert gas atmosphere to obtain first metal (M¹) oxide and a lithium halide, and
performing a solid-phase reaction of the first metal (M¹) oxide, lithium halide, and second metal (M²)-containing halide to prepare the lithium halide-based nanocomposite represented by any one of Chemical Formulas 1A to 1C according to claim 1.

28. A method for preparing a lithium halide-based nanocomposite represented by any one of Chemical Formulas 2A to 2C, comprising
performing a solid-phase reaction of a lithium-containing oxidizing agent; a first halide of first metal (M¹) or a second metal (M²) and a second halide of first metal (M¹) or second metal (M²); and a lithium-containing first halide and a lithium-containing second halide under an inert gas atmosphere to prepare a lithium halide-based nanocomposite in which M¹ and M² are same in Chemical Formulas 2A to 2C according to claim 10; or
performing a solid-phase reaction of a lithium-containing oxidizing agent, a first metal (M¹)-containing first halide, and a first metal (M¹)-containing second halide under an inert gas atmosphere to obtain a first metal (M¹) oxide, a lithium-containing first halide, and a lithium-containing second halide, and performing a solid-phase reaction of the first metal (M¹) oxide, lithium-containing first halide, lithium-containing second halide, second metal (M²)-containing first halide, and second metal (M²)-containing second halide to prepare a lithium halide-based nanocomposite in which M¹ and M² are different from each other in Chemical Formulas 2A to 2C according to claim 10.

29. A method for preparing a lithium halide-based nanocomposite represented by any one of Chemical Formulas 3A to 3C, comprising
performing a solid-phase reaction of a lithium-containing oxidizing agent, a first metal (M¹)-containing halide, and optionally a lithium halide under an inert gas atmosphere to prepare the lithium halide-based nanocomposite in which M¹ and M² are same in Chemical Formulas 1A to 1C; or
performing a solid-phase reaction of a lithium-containing oxidizing agent and a first metal (M¹)-containing halide under an inert gas atmosphere to obtain first metal (M¹) oxide and a lithium halide; and performing a solid-phase reaction of the first metal (M¹) oxide, lithium halide, and second metal (M²)-containing halide to prepare a lithium halide-based nanocomposite in which M¹ and M² are different from each other in Chemical Formulas 1A to 1C, and
performing a solid-phase reaction of the lithium halide-based nanocomposite, a third metal (M³)-containing halide and optionally lithium halide to prepare the lithium halide-based nanocomposite represented by any one of Chemical Formulas 3A to 3C according to claim 19.

30. A positive electrode active material for a rechargeable lithium battery comprising
a core including a composite metal oxide capable of reversible intercalation/deintercalation of lithium; and
a shell disposed on the core and including the lithium halide-based nanocomposite,
wherein the lithium halide-based nanocomposite is the lithium halide-based nanocomposite according to claim 1.

31. A positive electrode active material for a rechargeable lithium battery comprising
a core including a composite metal oxide capable of reversible intercalation/deintercalation of lithium; and
a shell disposed on the core and including the lithium halide-based nanocomposite,
wherein the lithium halide-based nanocomposite is the lithium halide-based nanocomposite according to claim 10.

32. A positive electrode active material for a rechargeable lithium battery comprising
a core including a composite metal oxide capable of reversible intercalation/deintercalation of lithium; and
a shell disposed on the core and including the lithium halide-based nanocomposite,
wherein the lithium halide-based nanocomposite is the lithium halide-based nanocomposite according to claim 19.

33. A solid electrolyte for a rechargeable lithium battery comprising the lithium halide-based nanocomposite according to claim 1 and a sulfide-based solid electrolyte.

34. A solid electrolyte for a rechargeable lithium battery comprising the lithium halide-based nanocomposite according to claim 10 and a sulfide-based solid electrolyte.

35. A solid electrolyte for a rechargeable lithium battery comprising the lithium halide-based nanocomposite according to claim 19 and a sulfide-based solid electrolyte.

36. A double-layer solid electrolyte for a rechargeable lithium battery comprising
a solid electrolyte for a positive electrode including the lithium halide-based nanocomposite of claim 1; and
a solid electrolyte for a negative electrode disposed on the solid electrolyte for the positive electrode and including a sulfide-based solid electrolyte.

37. A double-layer solid electrolyte for a rechargeable lithium battery comprising
a solid electrolyte for a positive electrode including the lithium halide-based nanocomposite of claim 10; and
a solid electrolyte for a negative electrode disposed on the solid electrolyte for the positive electrode and including a sulfide-based solid electrolyte.

38. A double-layer solid electrolyte for a rechargeable lithium battery comprising
a solid electrolyte for a positive electrode including the lithium halide-based nanocomposite of claim 19; and
a solid electrolyte for a negative electrode disposed on the solid electrolyte for the positive electrode and including a sulfide-based solid electrolyte.

39. An all-solid-state battery, comprising
a positive electrode;
a negative electrode; and
the solid electrolyte of claim 33 between the positive electrode and the negative electrode.

40. An all-solid-state battery, comprising
a positive electrode;
a negative electrode; and
the solid electrolyte of claim 34 between the positive electrode and the negative electrode.

41. An all-solid-state battery, comprising
a positive electrode;
a negative electrode; and
the solid electrolyte of claim 35 between the positive electrode and the negative electrode.

42. An all-solid-state battery comprising
a positive electrode;
a negative electrode; and
the double-layer solid electrolyte of claim 36 between the positive electrode and negative electrode;
wherein the positive electrode is disposed on the solid electrolyte for the positive electrode of the double-layer solid electrolyte, and the negative electrode is disposed on the solid electrolyte for the negative electrode of the double-layer solid electrolyte.

43. An all-solid-state battery comprising
a positive electrode;
a negative electrode; and
the double-layer solid electrolyte of claim 37 between the positive electrode and negative electrode;
wherein the positive electrode is disposed on the solid electrolyte for the positive electrode of the double-layer solid electrolyte, and the negative electrode is disposed on the solid electrolyte for the negative electrode of the double-layer solid electrolyte.

44. An all-solid-state battery comprising
a positive electrode;
a negative electrode; and
the double-layer solid electrolyte of claim 38 between the positive electrode and negative electrode;
wherein the positive electrode is disposed on the solid electrolyte for the positive electrode of the double-layer solid electrolyte, and the negative electrode is disposed on the solid electrolyte for the negative electrode of the double-layer solid electrolyte.
